(19) United States
(12) Patent Application Publication
(10) Pub. No.: US 2023/0417920 A1
(43) Pub. Date: Dec. 28, 2023

(54) RANGING SENSOR, RANGING SYSTEM, AND ELECTRONIC DEVICE

(71) Applicant: SONY SEMICONDUCTOR SOLUTIONS CORPORATION, KANAGAWA (JP)

(72) Inventors: YUSUKE MORIYAMA, TOKYO (JP); KUMIKO MAHARA, KANAGAWA (JP); OSAMU OZAWA, KANAGAWA (JP)

(21) Appl. No.: 18/247,752

(22) PCT Filed: Sep. 28, 2021
(86) PCT No.: PCT/JP2021/035517

§ 371 Date: Apr. 4, 2023

(30) Foreign Application Priority Data
Oct. 12, 2020 (JP) 2020-171679

(51) Int. Cl. G01S 17/894; G01S 7/4863; G01S 7/4865

(52) U.S. Cl. CPC G01S 17/894; G01S 7/4865; G01S 7/4863

(57) ABSTRACT

The present technology relates to a ranging sensor, a ranging system, and an electronic device capable of efficiently arranging circuits that implement ranging by different ranging methods. A ranging sensor includes a light emission control circuit that generates a light emission pulse that controls a light emission timing of irradiation light, a pixel modulation unit that performs charge distribution control in a pixel by an indirect ToF method, and a TDC that generates a count value corresponding to a flight time of the irradiation light by a direct ToF method, in which the light emission control circuit is arranged adjacent to the pixel modulation unit and the TDC. The present technology is applicable to, for example, a ranging sensor that measures a distance to a subject.

### TECHNICAL FIELD

The present technology relates to a ranging sensor, a ranging system, and an electronic device, and especially relates to a ranging sensor, a ranging system, and an electronic device that enable efficient arrangement of circuits that implement ranging by different ranging methods.

### BACKGROUND ART

Recently, a ranging sensor that measures a distance by a time-of-flight (ToF) method has attracted attention. The ranging sensor includes a direct ToF method capable of measuring a relatively long distance and an indirect ToF method capable of measuring a relatively short distance with high accuracy. For example, Patent Document 1 discloses the ranging sensor of the direct ToF method. Furthermore, Patent Document 2 discloses the ranging sensor of the indirect ToF method.

### CITATION LIST

### Patent Document

Patent Document 1: International Publication No. 2018/074530
Patent Document 2: Japanese Patent Application Laid-Open No. 2011-86904

### SUMMARY OF THE INVENTION

### Problems to be Solved by the Invention

When forming a ranging device, by using a plurality of ranging sensors of different ranging methods, it is possible to cover a wide ranging range and improve ranging accuracy.

However, for example, when the ranging sensor of the direct ToF method and the ranging sensor of the indirect ToF method are simply combined, a device scale becomes large and a cost increases.

The present disclosure is achieved in view of such a situation and an object thereof is to efficiently arrange circuits that implement ranging by different ranging methods.

### Solutions to Problems

A ranging sensor according to a first aspect of the present technology includes a light emission control circuit that generates a light emission pulse that controls a light emission timing of irradiation light, a pixel modulation unit that performs charge distribution control in a pixel by a first ToF method, and a TDC that generates a count value corresponding to a flight time of the irradiation light by a second ToF method, in which the light emission control circuit is arranged adjacent to the pixel modulation unit and the TDC.

A ranging system according to a second aspect of the present technology includes a light emission unit that emits irradiation light, and a ranging sensor that receives reflected light, which is the irradiation light reflected by an object, in which the ranging sensor includes a light emission control circuit that generates a light emission pulse that controls a light emission timing of the irradiation light, a pixel modulation unit that performs charge distribution control in a pixel by a first ToF method, and a TDC that generates a count value corresponding to a flight time of the irradiation light by a second ToF method, and the light emission control circuit is arranged adjacent to the pixel modulation unit and the TDC.

An electronic device according to a third aspect of the present technology includes a light emission unit that emits irradiation light, and a ranging sensor that receives reflected light, which is the irradiation light reflected by an object, in which the ranging sensor includes a light emission control circuit that generates a light emission pulse that controls a light emission timing of the irradiation light, a pixel modulation unit that performs charge distribution control in a pixel by a first ToF method, and a TDC that generates a count value corresponding to a flight time of the irradiation light by a second ToF method, and the light emission control circuit is arranged adjacent to the pixel modulation unit and the TDC.

In the first to third aspects of the present technology, a light emission control circuit that generates a light emission pulse that controls a light emission timing of irradiation light is arranged adjacent to a pixel modulation unit that performs charge distribution control in a pixel by a first ToF method, and a TDC that generates a count value corresponding to a flight time of the irradiation light by a second ToF method.

The ranging sensor, the ranging system, and the electronic device may be independent devices or may be modules incorporated in other devices.

### BRIEF DESCRIPTION OF DRAWINGS

FIG. 1 is a block diagram depicting a configuration example of a ranging system according to an embodiment of the present disclosure.

FIG. 2 is a block diagram depicting a detailed configuration example of the ranging sensor in FIG. 1.

FIG. 3 is a perspective view depicting a substrate configuration example of the ranging sensor in FIG. 1.

FIG. 4 is a plan view depicting a first configuration example of each substrate of the ranging sensor.

FIG. 5 is a diagram illustrating a first configuration example of an iToF pixel.

FIG. 6 is a diagram illustrating a second configuration example of the iToF pixel.

FIG. 7 is a diagram illustrating a first configuration example of a dToF pixel.

FIG. 8 is a diagram illustrating a second configuration example of the dToF pixel.

FIG. 9 is a diagram illustrating a third configuration example of the dToF pixel.

FIG. 10 is a diagram illustrating a fourth configuration example of the dToF pixel.

FIG. 11 is a timing chart for illustrating an operation of the ranging sensor according to the first configuration example.

FIG. 12 is a plan view depicting a second configuration example of each substrate of the ranging sensor.

FIG. 13 is a simplified cross-sectional view taken along lines A-A′ and B-B′ in FIG. 12.

FIG. 14 is a plan view depicting a third configuration example of each substrate of the ranging sensor.

FIG. 15 is a plan view depicting a fourth configuration example of each substrate of the ranging sensor.

FIG. 16 is a plan view depicting a fifth configuration example of each substrate of the ranging sensor.

FIG. 17 is a plan view depicting a sixth configuration example of each substrate of the ranging sensor.

FIG. 18 is a simplified cross-sectional view taken along lines A-A′ and B-B′ in FIG. 17.

FIG. 19 is a block diagram illustrating a detailed configuration example of a light emission control circuit.

FIG. 20 is a timing chart illustrating an operation of the light emission control circuit in FIG. 19, and a light emitting operation and a light receiving operation corresponding to the same.

FIG. 21 is a block diagram depicting a configuration example of a smartphone in which the ranging system in FIG. 1 is mounted as a ranging module.

FIG. 22 is a block diagram depicting an example of schematic configuration of a vehicle control system.

FIG. 23 is a diagram of assistance in explaining an example of installation positions of an outside-vehicle information detecting section and an imaging section.

### MODE FOR CARRYING OUT THE INVENTION

A mode for carrying out the present technology (hereinafter, referred to as an embodiment) is hereinafter described with reference to the attached drawings.
1. Configuration Example of Ranging System
2. Detailed Block Diagram of Ranging Sensor
3. Substrate Configuration Example of Ranging Sensor
4. First Configuration Example of Ranging Sensor Configuration Example of iToF Pixel/dToF Pixel
6. Operation of Ranging Sensor according to First Configuration Example
7. Second Configuration Example of Ranging Sensor
8. Third Configuration Example of Ranging Sensor
9. Fourth Configuration Example of Ranging Sensor Fifth Configuration Example of Ranging Sensor
11. Sixth Configuration Example of Ranging Sensor
12. Configuration Example of Light Emission Control Circuit
13. Configuration Example of Electronic Device
14. Application Example to Mobile Body

Note that, in the drawings referred to in the following description, the same or similar portions are denoted by the same or similar reference signs. Note that, the drawings are schematic, and a relationship between a thickness and a planar dimension, a ratio of the thicknesses between respective layers and the like are different from actual ones. Furthermore, there is a case where dimensional relationships and ratios are partly different between the drawings.

Furthermore, definition of directions such as upward and downward directions in the following description is merely the definition for convenience of description, and does not limit the technical idea of the present disclosure. For example, if a target is observed while being rotated by 90°, the upward and downward directions are converted into rightward and leftward directions, and if the target is observed while being rotated by 180°, the upward and downward directions are inverted.

### 1. Configuration Example of Ranging System

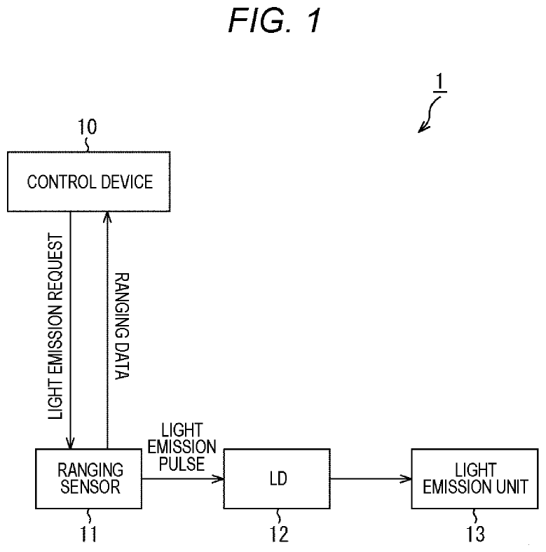

FIG. 1 is a block diagram depicting a configuration example of a ranging system according to an embodiment of the present disclosure.

A ranging system 1 in FIG. 1 includes a control device 10, a ranging sensor 11, an LD 12, and a light emission unit 13.

The control device 10 is a device that controls ranging using a time-of-flight (ToF) method and light emission for this. When receiving an instruction of ranging from a host device of a higher level, for example, the control device 10 supplies a light emission request to the ranging sensor 11. Furthermore, the control device 10 obtains ranging data, which is a result of ranging performed by the ranging sensor in response to the light emission request, from the ranging sensor 11.

In response to the light emission request from the control device 10, the ranging sensor 11 allows the light emission unit 13 to emit irradiation light, and receives reflected light, which is the irradiation light reflected by an object, thereby measuring a distance to the object to output.

The ranging sensor 11 measures the distance by a direct ToF method and an indirect ToF method. The indirect ToF method is a method of detecting a flight time from a timing at which the irradiation light is emitted to a timing at which the reflected light is received as a phase difference to calculate the distance to the object, the method capable of implementing measurement in a relatively short-distance range with high accuracy. In contrast, the direct ToF method is a method of directly measuring the flight time from the timing at which the irradiation light is emitted to the timing at which the reflected light is received to calculate the distance to the object, the method effective for measuring a long distance as compared to the indirect ToF method. Hereinafter, for simplicity, the direct ToF method is referred to as dToF, the indirect ToF method is referred to as iToF, ranging by the direct ToF method is referred to as dToF ranging, and ranging by the indirect ToF method is referred to as iToF ranging.

Since ranging accuracy is different between the iToF ranging and the dToF ranging, the ranging sensor 11 performs the ranging by both the iToF and dToF for the same ranging range. Note that, in order to prevent interference of the received reflected light, the ranging sensor 11 executes the dToF ranging and iToF ranging in a time division manner, and outputs the ranging data obtained by measuring the distance to a subject to the control device 10.

For example, supposing that the ranging is performed in the order of the iToF ranging and the dToF ranging, when obtaining the light emission request from the control device 10, the ranging sensor 11 supplies a light emission pulse for the iToF ranging to the LD 12, and allows the light emission unit 13 to emit the irradiation light. Then, the ranging sensor 11 receives the reflected light from the object as the subject, measures the distance to the object by the iToF ranging on the basis of a light reception result, and outputs the same to the control device 10. Next, the ranging sensor 11 supplies a light emission pulse for the dToF ranging to the LD 12, and allows the light emission unit 13 to emit the irradiation light. Then, the ranging sensor 11 receives the reflected light from a predetermined object as the subject, measures the distance to the object by the dToF ranging on the basis of a light reception result, and outputs the same to the control device 10.

Note that, as a matter of course, the ranging sensor 11 does not necessarily perform both the iToF ranging and dToF ranging, and may execute only one of them and output the ranging data to the control device 10. In this case, for example, the control device 10 supplies the light emission request while specifying which of the iToF ranging or dToF ranging is to be performed.

The LD 12 is a laser driver that drives the light emission unit 13, drives the light emission unit 13 on the basis of the light emission pulse from the ranging sensor 11, and allows the light emission unit 13 to output the irradiation light.

The light emission unit 13 includes, for example, a vertical cavity surface emitting laser LED (VCSEL LED) and the like, and emits the irradiation light by the drive of the LD 12.

### 2. Detailed Block Diagram of Ranging Sensor

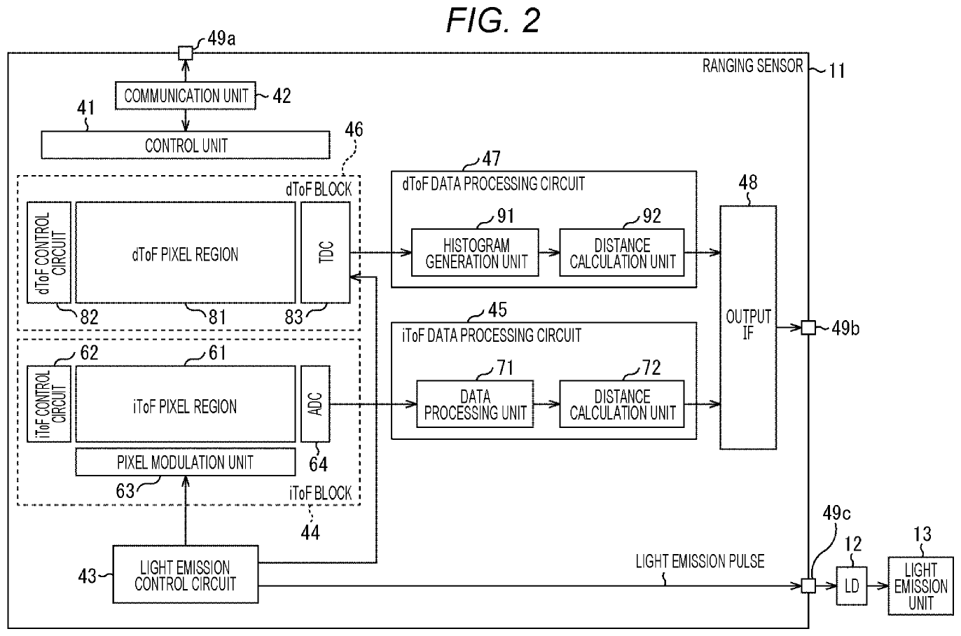

FIG. 2 is a block diagram depicting a detailed configuration example of the ranging sensor 11.

The ranging sensor 11 includes a control unit 41, a communication unit 42, a light emission control circuit 43, an iToF block 44, an iToF data processing circuit 45, a dToF block 46, a dToF data processing circuit 47, an output IF 48, and input/output terminals 49a to 49c.

The iToF block 44 includes an iToF pixel region 61, an iToF control circuit 62, a pixel modulation unit 63, and an ADC 64, and the iToF data processing circuit 45 includes a data processing unit 71 and a distance calculation unit 72. The dToF block 46 includes a dToF pixel region 81, a dToF control circuit 82, and a TDC 83, and the dToF data processing circuit 47 includes a histogram generation unit 91 and a distance calculation unit 92.

Note that, hereinafter, in a case where a pixel for iToF arranged in the iToF block 44 and a pixel for dToF arranged in the dToF block 46 are distinguished from each other, they are referred to as an iToF pixel and a dToF pixel, respectively.

The control unit 41 controls an entire operation of the ranging sensor 11. For example, the control unit 41 controls the light emission control circuit 43 on the basis of the light emission request from the control device 10 obtained via the communication unit 42, and allows the light emission control circuit 43 to output the light emission pulse to the LD 12. The light emission pulse output to the LD 12 is also supplied to the pixel modulation unit 63 and the TDC 83.

The communication unit 42 communicates a predetermined message such as the light emission request and the ranging data between the control unit 41 and the control device 10.

Under the control of the control unit 41, the light emission control circuit 43 generates the light emission pulse for controlling the light emission timing of the irradiation light for the iToF ranging or the dToF ranging, and outputs the same to the LD 12 via the input/output terminal 49c.

Furthermore, the light emission control circuit 43 also supplies the generated light emission pulse to the pixel modulation unit 63 at the time of the iToF ranging, and also supplies the generated light emission pulse to the TDC 83 at the time of the dToF ranging.

The iToF block 44 includes a plurality of iToF pixels two-dimensionally arranged in a matrix, and supplies a pixel signal corresponding to an amount of reflected light detected by each pixel to the iToF data processing circuit 45.

Specifically, the iToF pixel region 61 includes a plurality of iToF pixels two-dimensionally arranged in a matrix, and each iToF pixel includes two charge accumulation units. Each iToF pixel alternately accumulates charges corresponding to the amount of received light in the two charge accumulation units according to the control of the pixel modulation unit 63, thereby generating detection signals of two light reception timings whose phases are inverted such as a phase of 0 degrees and a phase of 180 degrees as pixel signals, for example, and outputs the same to the ADC 64.

The iToF control circuit 62 performs drive of reset of the charge, reading of the pixel signal and the like on each iToF pixel in the iToF pixel region 61. The pixel modulation unit 63 performs distribution control of distributing the charges accumulated in each iToF pixel to the two charge accumulation units in synchronization with the light emission pulse supplied from the light emission control circuit 43. The analog digital converter (ADC) 64 performs AD conversion on the pixel signal (detection signal) supplied from each iToF pixel in the iToF pixel region 61, and supplies the same to the data processing unit 71 of the iToF data processing circuit 45.

The data processing unit 71 of the iToF data processing circuit 45 performs various types of data processing such as binning processing, filter processing, or error determination processing on pixel data from the ADC 64, and supplies the same to the distance calculation unit 72. The distance calculation unit 72 calculates the distance to the object as the subject on the basis of the pixel data supplied from the data processing unit 71, and supplies the same to the output IF 48.

The dToF block 46 includes a plurality of dToF pixels two-dimensionally arranged in a matrix, and supplies a pixel signal corresponding to an amount of reflected light detected by each dToF pixel to the dToF data processing circuit 47.

Specifically, the dToF pixel region 81 includes a plurality of dToF pixels two-dimensionally arranged in a matrix, and each dToF pixel includes, for example, a single photon avalanche diode (SPAD) as a photoelectric conversion element. In the SPAD, avalanche amplification occurs when one photon enters a PN junction region of a high electric field in a state in which a voltage larger than a breakdown voltage is applied. By detecting a timing at which a current instantaneously flows at that time, it is possible to measure a time until the light emitted from the light emission unit 13 is reflected by the subject to return. Each dToF pixel generates a pixel signal indicating a timing at which the photon enters, and outputs the same to the TDC 83.

The dToF control circuit 82 switches between an active pixel and an inactive pixel and the like for each dToF pixel in the dToF pixel region 81. The active pixel is a pixel that detects incidence of the photon, and the inactive pixel is a pixel that does not detect the incidence of the photon. Therefore, the dToF control circuit 82 controls on/off of light reception of each dToF pixel in the dToF pixel region 81. For example, the dToF control circuit 82 performs control to set at least a part of the plurality of dToF pixels in the dToF pixel region 81 as the active pixels and set the remaining dToF pixels as the inactive pixels at a predetermined timing in accordance with the light emission pulse from the light emission control circuit 43. It goes without saying that all the dToF pixels in the dToF pixel region 81 may be set as the active pixels.

For each dToF pixel set as the active pixel in the dToF pixel region 81, the TDC 83 generates a count value corresponding to the flight time from when the light emission unit 13 emits the irradiation light to when the active pixel receives the light on the basis of the pixel signal of the active pixel and the light emission pulse from the light emission control circuit 43, and supplies the same to the histogram generation unit 91 of the dToF data processing circuit 47.

The histogram generation unit 91 of the dToF data processing circuit 47 creates a histogram of the flight time (count value) until the reflected light is received for each pixel on the basis of the emission of the irradiation light repeatedly executed a predetermined number of times (for example, several to several hundred times) and the reception of the reflected light. Then, by detecting a peak of the histogram, the histogram generation unit 91 determines the flight time until the light emitted from the light emission unit 13 is reflected by the subject to return, and supplies the same to the distance calculation unit 92. The distance calculation unit 92 calculates the distance to the subject for each pixel from the flight time determined for each dToF pixel, and supplies the same to the output IF 48.

The output IF 48 outputs the distance to the object supplied in units of pixels from the distance calculation unit 72 of the iToF data processing circuit 45 to the control device 10 via the input/output terminal 49b as the ranging data. Furthermore, the output IF 48 outputs the distance to the object supplied in units of pixels from the distance calculation unit 92 of the dToF pixel region 81 to the control device 10 via the input/output terminal 49b as the ranging data.

The ranging sensor 11 has the above-described configuration, controls the light emission timing of the irradiation light, receives the reflected light, which is the irradiation light reflected by the object to return, and outputs at least one of the ranging data by the iToF or the ranging data by the dToF.

### 3. Substrate Configuration Example of Ranging Sensor

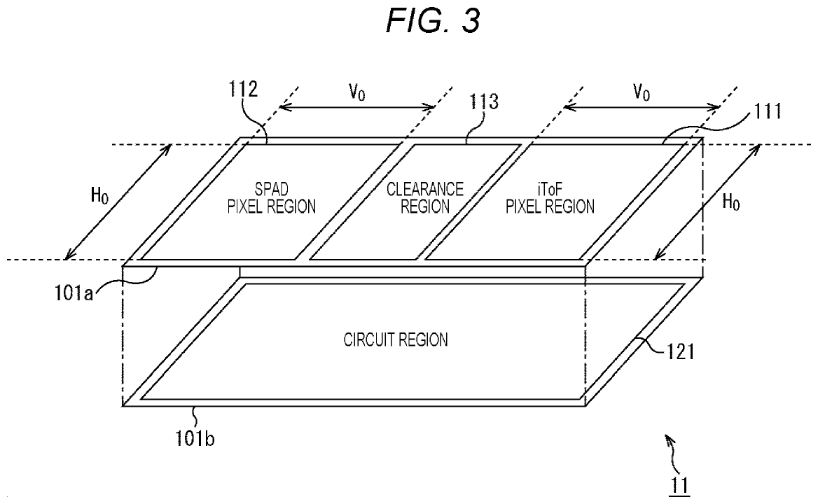

FIG. 3 is a perspective view depicting a substrate configuration example of the ranging sensor 11.

As illustrated in FIG. 3, the ranging sensor 11 is a chip having a stacked structure in which a first semiconductor substrate 101a and a second semiconductor substrate 101b formed by using a semiconductor substrate such as silicon are stacked. The first semiconductor substrate 101a and the second semiconductor substrate 101b are electrically connected to each other by, for example, a through via or a metallic bonding such as Cu—Cu. A light receiving region that receives the reflected light from the object is formed on the first semiconductor substrate 101a, and in a case where the chip of the ranging sensor 11 is mounted on a predetermined external substrate, the first semiconductor substrate 101a is on an upper side. Hereinafter, the first semiconductor substrate 101a is referred to as an upper substrate 101a, and the second semiconductor substrate 101b is referred to as a lower substrate 101b for easier distinction.

On the upper substrate 101a, an iToF pixel region 111, a SPAD pixel region 112, and a clearance region 113 are formed. The iToF pixel region 111, the SPAD pixel region 112, and the clearance region 113 are arranged side by side with the clearance region 113 at the center.

In the iToF pixel region 111, a plurality of iToF pixels that receives the reflected light at the time of the iToF ranging is two-dimensionally arranged in a matrix. The iToF pixel region 111 is the same as the iToF pixel region 61 illustrated in FIG. 2.

In the SPAD pixel region 112, a plurality of dToF pixels that receives the reflected light at the time of the dToF ranging is two-dimensionally arranged in a matrix. The SPAD pixel region 112 is a part of the dToF pixel region 81 illustrated in FIG. 2, and is a region in which only the SPADs of the respective dToF pixels are arranged in a matrix.

The number and a pixel size of the respective pixels arrayed in the iToF pixel region 111 and the SPAD pixel region 112 are the same, and a region size Ho in a horizontal direction and a region size Vo in a vertical direction of the iToF pixel region 111 and the SPAD pixel region 112 are the same. Therefore, it is configured such that a measurement region of the iToF ranging and that of the dToF ranging are the same. Note that, they may be changed depending on a design, and may be different from each other.

The clearance region 113 is a region provided such that the iToF pixel in the iToF pixel region 111 and the dToF pixel in the SPAD pixel region 112 do not affect each other, and is arranged between the iToF pixel region 111 and the SPAD pixel region 112.

On the lower substrate 101b, a circuit region 121 in which various circuits that perform drive control of each pixel in the iToF pixel region 111 and the SPAD pixel region 112, signal processing of the pixel signal output from each pixel, drive control of the LD 12 and the like are formed is arranged.

### 4. First Configuration Example of Ranging Sensor

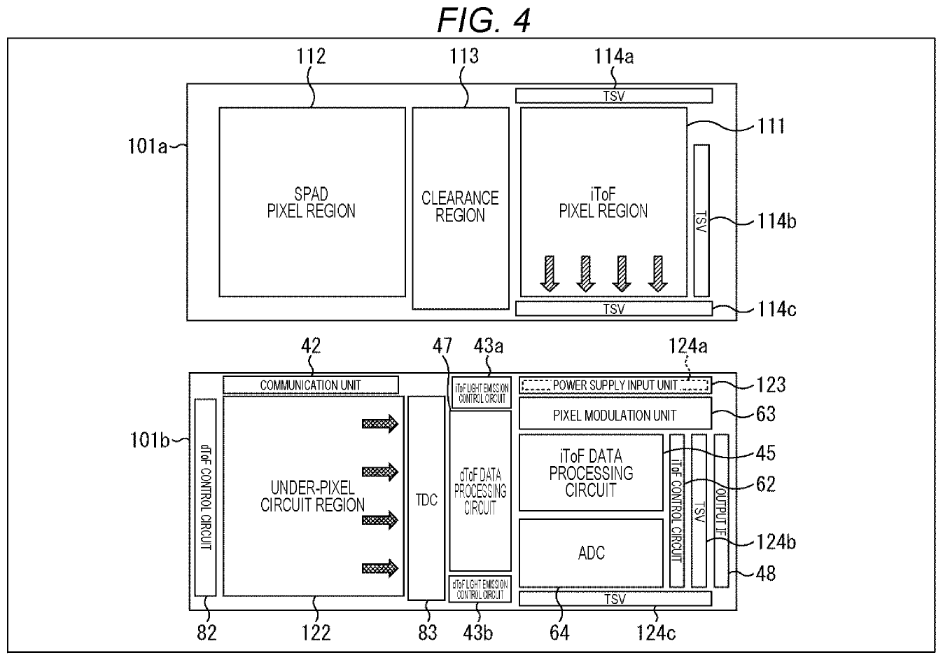

FIG. 4 is a plan view depicting a first configuration example of each substrate of the ranging sensor 11.

In FIG. 4, a portion corresponding to that in FIGS. 2 and 3 is assigned with the same reference sign and the detailed description of the portion is omitted.

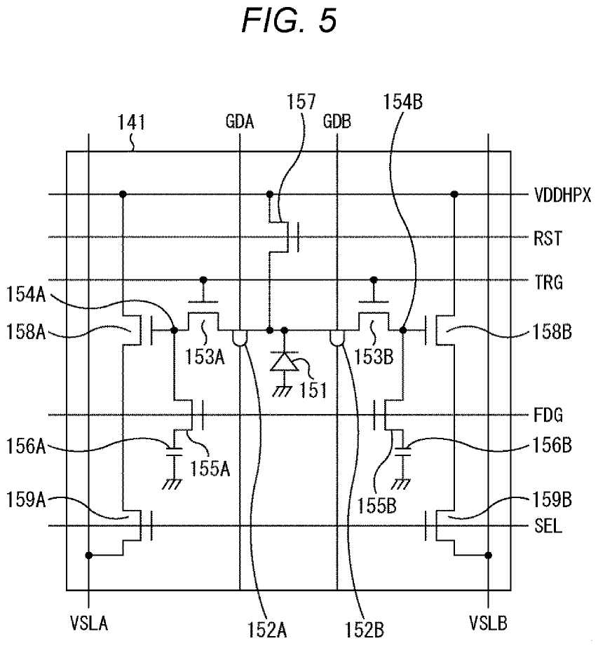

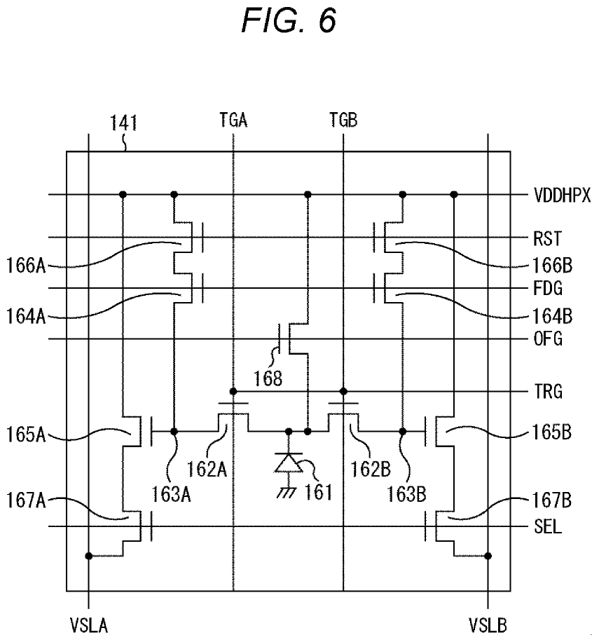

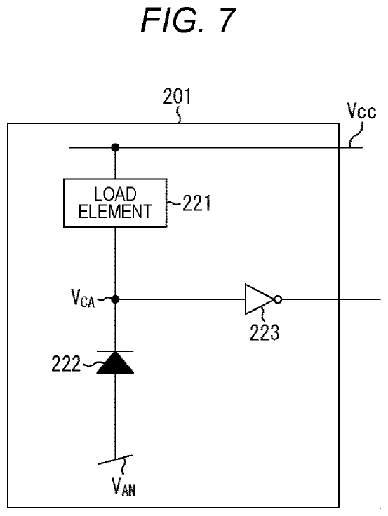

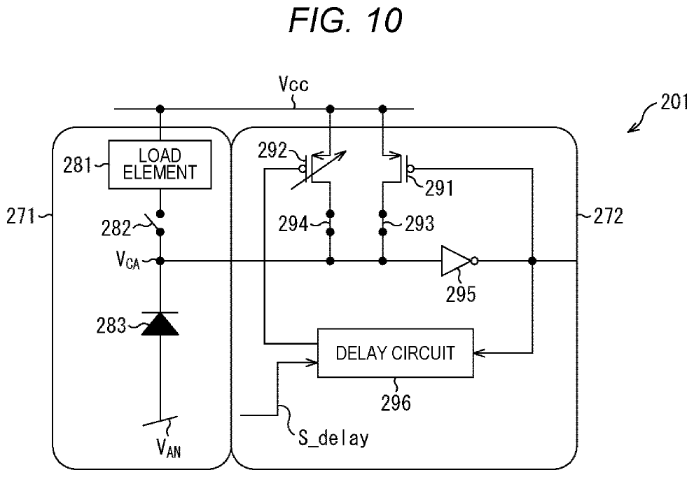

On the upper substrate 101a, as described above, the iToF pixel region 111 and the SPAD pixel region 112 are arranged on right and left sides with the clearance region 113 interposed therebetween. TSV regions 114a to 114c in which a through-silicon via (TSV) electrically connected to the lower substrate 101b is arranged are arranged outside three sides of a rectangularly formed iToF pixel region 111. A circuit configuration of the iToF pixel in the iToF pixel region 111 is described later with reference to FIGS. 5 and 6. A circuit configuration of the dToF pixel in the SPAD pixel region 112 is described later with reference to FIGS. 7 and 10.

In contrast, on the lower substrate 101b, the pixel modulation unit 63, the iToF data processing circuit 45, the ADC 64, and the iToF control circuit 62 are arranged in a region under the iToF pixel region 111 of the upper substrate 101a.

A power supply input unit 123 in which a terminal unit that receives a power supply input from an external substrate on which this is mounted is arranged is arranged outside the pixel modulation unit 63. The power supply input unit 123 includes a TSV region 124a corresponding to the TSV region 114a of the upper substrate 101a, and supplies a predetermined power supply voltage input from the external substrate also to the upper substrate 101a.

A TSV region 124b is arranged at a position on the lower substrate 101b corresponding to the TSV region 114b of the upper substrate 101a. The TSV region 124b supplies, to the upper substrate 101a, a drive signal of reset of the charge of each iToF pixel, reading of the pixel signal and the like output by the iToF control circuit 62 of the lower substrate 101b.

A TSV region 124c is arranged at a position on the lower substrate 101b corresponding to the TSV region 114c of the upper substrate 101a. The TSV region 124c supplies the pixel signal output from each iToF pixel in the iToF pixel region 61 of the upper substrate 101a to the ADC 64 of the lower substrate 101b.

The output IF 48 is arranged outside the iToF control circuit 62 of the lower substrate 101b. The output IF 48 includes the input/output terminal 49b.

An under-pixel circuit region 122 is arranged in a region under the SPAD pixel region 112 of the upper substrate 101a. The under-pixel circuit region 122 is a region in which a pixel circuit other than the SPAD of the dToF pixel is formed. A circuit configuration of the dToF pixel formed in the under-pixel circuit region 122 is described later with reference to FIGS. 7 to 10.

The communication unit 42, the dToF control circuit 82, and the TDC 83 are arranged outside three sides of a rectangularly formed under-pixel circuit region 122. The TDC 83 is arranged under the clearance region 113 of the upper substrate 101a. In addition to the TDC 83, the dToF data processing circuit 47 is also arranged in a portion on the lower substrate 101b corresponding to the clearance region 113.

The light emission control circuit 43 is arranged so as to be divided into an iToF light emission control circuit 43a that generates the light emission pulse in a case of performing the iToF ranging, and a dToF light emission control circuit 43b that generates the light emission pulse in a case of performing the dToF ranging. The iToF light emission control circuit 43a is arranged adjacent to the power supply input unit 123 and the pixel modulation unit 63, and the dToF light emission control circuit 43b is arranged adjacent to the TDC 83 and the dToF data processing circuit 47.

In the ranging sensor 11 in the first configuration example arranged in the above-described manner, the pixel signal generated by each iToF pixel in the iToF pixel region 111 is transferred in a longitudinal direction indicated by hatched arrows and supplied to the ADC 64 via the TSV region 114c and the TSV region 124c. Then, after the pixel signal is AD-converted by the ADC 64, the distance to the object is calculated by the iToF data processing circuit 45 and output from the output IF 48.

In contrast, the signal generated by each dToF pixel in the SPAD pixel region 112 is transferred to the under-pixel circuit region 122 by Cu—Cu junction and the like, transferred in a lateral direction indicated by cross-hatched arrows in the under-pixel circuit region 122, and supplied to the TDC 83. Then, by the TDC 83, the count value corresponding to the flight time from the light emission to the light reception is generated and supplied to the dToF data processing circuit 47. By the dToF data processing circuit 47, the distance to the subject is calculated for each pixel by generating the histogram of the count values, and is output from the output IF 48.

According to the arrangement of the respective substrates according to the first configuration example described above, it is possible to efficiently arrange the circuits that implement the ranging by different ranging methods of iToF and dToF.

### 5. Configuration Example of iToF Pixel/dToF Pixel

Next, configurations of the iToF pixel and the dToF pixel are described with reference to FIGS. 5 to 10. First, the configuration of the iToF pixel is described.

### First Configuration Example of iToF Pixel

FIG. 5 illustrates a first configuration example of the iToF pixel.

An iToF pixel 141 in FIG. 5 is a circuit of a pixel referred to as a current assisted photonic demodulator (CAPD) system that distributes photoelectrically converted charges by directly applying a voltage to a semiconductor substrate to generate a current in the substrate and modulating a wide-range region in the substrate at high speed.

The iToF pixel 141 includes a photoelectric conversion unit 151, voltage application units 152A and 152B, transfer transistors 153A and 153B, floating diffusion regions (FDs) 154A and 154B, FD gate transistors 155A and 155B, additional capacitances 156A and 156B, a reset transistor 157, amplification transistors 158A and 158B, and selection transistors 159A and 159B.

That is, suppose that two distribution destinations to which the charges generated by the photoelectric conversion unit 151 are distributed are referred to as a first tap and a second tap, two voltage application units 152, two transfer transistors 153, two FDs 154, two FD gate transistors 155, two additional capacitances 156, two amplification transistors 158, and two selection transistors 159 are provided corresponding to the first tap and the second tap. In FIG. 5, A is assigned to a reference sign of an element on the first tap side, and B is assigned to a reference sign of an element on the second tap side. The reset transistor 157 is provided in common to the first tap and the second tap.

A first voltage GDA is applied to the voltage application unit 152A of the first tap, and a second voltage GDB is applied to the voltage application unit 152B of the second tap; the first voltage GDA and the second voltage GDB are subjected to modulation control at high speed by the pixel modulation unit 63. For example, drive in which the first voltage GDA is set to 1.5 V and the second voltage GDB is set to 0 V at a predetermined timing and the first voltage GDA is set to 0 V and the second voltage GDB is set to 1.5 V at a next timing is repeated at a high speed. In a case where the first voltage GDA is set to 1.5 V and the second voltage GDB is set to 0 V, the charge generated in the semiconductor substrate moves to the voltage application unit 152A side of the first tap. In contrast, in a case where the first voltage GDA is set to 0 V and the second voltage GDB is set to 1.5 V, the charge generated in the semiconductor substrate moves to the voltage application unit 152B side of the second tap.

The transfer transistor 153A becomes conductive when a transfer drive signal TRG supplied to a gate electrode thereof is made active, and transfers the charge that moves to the voltage application unit 152A side of the first tap to the FD 154A. The transfer transistor 153B becomes conductive when a transfer drive signal TRG supplied to a gate electrode thereof is made active, and transfers the charge that moves to the voltage application unit 152B side of the second tap to the FD 154B. In FIG. 5, for the sake of simplicity, the configuration is such that there is one transfer drive signal TRG shared by the transfer transistors 153A and 153B, but actually, this is individually provided, and controlled to be turned on or off such that they are exclusively operated.

The FD 154A is a charge accumulation unit of the first tap that temporarily accumulates and holds the charge transferred from the photoelectric conversion unit 151. The FD 154B is a charge accumulation unit of the second tap that temporarily accumulates and holds the charge transferred from the photoelectric conversion unit 151.

The FD gate transistor 155A becomes conductive when a FD drive signal FDG supplied to a gate electrode thereof becomes active, and connects the FD 154A and the additional capacitance 156A to each other. The FD gate transistor 155B becomes conductive when a FD drive signal FDG supplied to a gate electrode thereof becomes active, and connects the FD 154B and the additional capacitance 156B to each other. In FIG. 5, for the sake of simplicity, the configuration is such that there is one FD drive signal FDG shared by the FD gate transistors 155A and 155B, but actually, this is individually provided, and controlled to be turned on or off such that they are exclusively operated.

The reset transistor 157 becomes conductive when a reset drive signal RST supplied to a gate electrode thereof becomes active, and resets potential of the photoelectric conversion unit 151.

The amplification transistor 158A is connected to a constant current source not illustrated when a source electrode thereof is connected to a vertical transfer line VSLA via the selection transistor 159A to form a source follower circuit. The amplification transistor 158B is connected to a constant current source not illustrated when a source electrode thereof is connected to a vertical transfer line VSLB via the selection transistor 159B to form a source follower circuit.

The selection transistor 159A is connected between the amplification transistor 158A and the vertical transfer line VSLA, becomes conductive when a selection signal SEL supplied to a gate electrode thereof becomes active, and outputs a signal output from the amplification transistor 158A to the vertical transfer line VSLA. The selection transistor 159B is connected between the amplification transistor 158B and the vertical transfer line VSLB, becomes conductive when a selection signal SEL supplied to a gate electrode thereof becomes active, and outputs a signal output from the amplification transistor 158B to the vertical transfer line VSLB. In FIG. 5, for the sake of simplicity, the configuration is such that there is one selection signal SEL shared by the selection transistors 159A and 159B, but actually, this is individually provided, and controlled to be turned on or off such that they are exclusively operated.

An operation of the iToF pixel 141 in FIG. 5 is described.

First, a reset operation of resetting the charge of the iToF pixel 141 is executed in all the pixels before light reception is performed.

That is, the transfer transistors 153A and 153B, the FD gate transistors 155A and 155B, and the reset transistor 157 are turned on, and the accumulated charges of the photoelectric conversion unit 151, the FDs 154A and 154B, and the additional capacitances 156A and 156B are discharged.

After the accumulated charges are discharged, the light reception is started in all the pixels.

That is, the first voltage GDA of the voltage application unit 152A of the first tap and the second voltage GDB of the voltage application unit 152B of the second tap are subjected to modulation control at high speed, and the transfer transistors 153A and 153B are alternately driven accordingly. Therefore, the charges generated by the photoelectric conversion unit 151 are alternately distributed and accumulated in the FD 154A or 154B. When the FD gate transistors 155A and 155B are turned on, they are also accumulated in the additional capacitances 156A and 156B.

The reflected light received by the iToF pixel 141 is delayed corresponding to the distance to the object from the timing at which the light emission unit 13 emits the irradiation light. Since a distribution ratio of the charges accumulated in the first tap and the second tap changes by a delay time corresponding to the distance to the object, the distance to the object may be obtained from the distribution ratio of the accumulated charges between the first tap and the second tap.

### Second Configuration Example of iToF Pixel

FIG. 6 illustrates a second configuration example of the iToF pixel.

The iToF pixel 141 in FIG. 6 includes a photodiode (PD) 161 as a photoelectric conversion unit. Furthermore, the iToF pixel 141 includes two transfer transistors 162, two floating diffusion regions (FDs) 163, two FD gate transistors 164, two amplification transistors 165, two reset transistors 166, and two selection transistors 167 corresponding to the first tap and the second tap. Moreover, the iToF pixel 141 includes a charge discharge transistor 168. In FIG. 6 also, A is assigned to a reference sign of an element on the first tap side, and B is assigned to a reference sign of an element on the second tap side.

The iToF pixel 141 in FIG. 6 is a circuit of a pixel referred to as a gate system that distributes the charges generated by the PD 161 to the first tap and the second tap by the transfer transistor 162, which is a gate transistor.

The PD 161 generates and accumulates the charge corresponding to the amount of received reflected light.

When a transfer drive signal TGA supplied to a gate electrode becomes active, the transfer transistor 162A becomes conductive in response to this, and transfers the charge accumulated in the PD 161 to the FD 163A. When a transfer drive signal TGB supplied to a gate electrode becomes active, the transfer transistor 162B becomes conductive in response to this, and transfers the charge accumulated in the PD 161 to the FD 163B.

The FD 163A is a charge accumulation unit of the first tap that temporarily accumulates and holds the charge transferred from the PD 161. The FD 163B is a charge accumulation unit of the second tap that temporarily accumulates and holds the charge transferred from the PD 161.

When the FD drive signal FDG supplied to a gate electrode becomes active, a FD gate transistor 164A becomes conductive in response to this and connects an additional capacitance between the FD gate transistor 164A and the reset transistor 166A to the FD 163A. When the FD drive signal FDG supplied to a gate electrode becomes active, a FD gate transistor 164B becomes conductive in response to this and connects an additional capacitance between the FD gate transistor 164B and the reset transistor 166B to the FD 163B. An accumulated capacitance may be changed by dynamically controlling on/off of the FD gate transistor 164 according to an amount of incident light. In FIG. 6, for the sake of simplicity, the configuration is such that there is one FD drive signal FDG shared by the FD gate transistors 164A and 164B, but actually, this is individually provided, and controlled to be turned on or off such that they are exclusively operated.

The amplification transistor 165A is connected to a constant current source not illustrated when a source electrode thereof is connected to a vertical transfer line VSLA via the selection transistor 167A to form a source follower circuit. The amplification transistor 165B is connected to a constant current source not illustrated when a source electrode thereof is connected to a vertical transfer line VSLB via the selection transistor 167B to form a source follower circuit.

When the reset drive signal RST supplied to a gate electrode becomes active, the reset transistor 166A becomes conductive in response to this, thereby resetting potential of the FD 163A. When the reset drive signal RST supplied to a gate electrode becomes active, the reset transistor 166B becomes conductive in response to this, thereby resetting potential of the FD 163B2. Note that, when the reset transistors 166A and 166B are made active, the FD gate transistors 164A and 164B are also made active at the same time. In FIG. 6, for the sake of simplicity, the configuration is such that there is one reset drive signal RST shared by the reset transistors 166A and 166B, but actually, this is individually provided, and controlled to be turned on or off such that they are exclusively operated.

The selection transistor 167A is connected between the amplification transistor 165A and the vertical transfer line VSLA, becomes conductive when the selection signal SEL supplied to a gate electrode thereof becomes active, and outputs a signal output from the amplification transistor 165A to the vertical transfer line VSLA. The selection transistor 167B is connected between the amplification transistor 165B and the vertical transfer line VSLB, becomes conductive when the selection signal SEL supplied to a gate electrode thereof becomes active, and outputs a signal output from the amplification transistor 165B to the vertical transfer line VSLB. In FIG. 6, for the sake of simplicity, the configuration is such that there is one selection signal SEL shared by the selection transistors 167A and 167B, but actually, this is individually provided, and controlled to be turned on or off such that they are exclusively operated.

When a discharge drive signal OFG supplied to a gate electrode becomes active, the charge discharge transistor 168 becomes conductive in response to this, thereby discharging the charge accumulated in the PD 161.

An operation of the iToF pixel 141 in FIG. 6 is described.

First, a reset operation of resetting the charge of the iToF pixel 141 is executed in all the pixels before light reception is performed.

That is, the FD gate transistors 164A and 164B and the reset transistors 166A and 166B are turned on, the accumulated charges of the FDs 163A and 163B are discharged, the charge discharge transistor 168 is turned on, and the accumulated charges of the PD 161 are discharged.

After the accumulated charges are discharged, the light reception is started in all the pixels.

That is, the transfer drive signals TGA and TGB are subjected to modulation control at high speed by the pixel modulation unit 63, and the transfer transistors 162A and 162B are alternately turned on. Therefore, the charges generated in the PD 161 are alternately distributed to the FD 163A or 163B to be accumulated. When the FD gate transistors 164A and 164B are turned on, they are also accumulated in the additional capacitances.

The reflected light received by the iToF pixel 141 is delayed corresponding to the distance to the object from the timing at which the light emission unit 13 emits the irradiation light. Since a distribution ratio of the charges accumulated in the first tap and the second tap changes by a delay time corresponding to the distance to the object, the distance to the object may be obtained from the distribution ratio of the accumulated charges between the first tap and the second tap.

Next, the configuration of the dToF pixel is described.

### First Configuration Example of dToF Pixel

FIG. 7 illustrates a first configuration example of the dToF pixel.

A dToF pixel 201 in FIG. 7 includes a load element (LOAD element) 221, a SPAD 222, and an inverter 223.

More specifically, one terminal of the load element 221 is connected to a power supply voltage Vcc, and the other terminal is connected to a cathode of the SPAD 222 and an input terminal of the inverter 223.

The other terminal of the load element 221 and the input terminal of the inverter 223 are connected to the cathode of the SPAD 222, and a predetermined power supply voltage V_{AN} is externally applied to an anode thereof. The SPAD 222 is a photodiode (single photon avalanche photodiode) that performs avalanche amplification on a generated electron and outputs a signal of a cathode voltage V_{CA} when incident light is incident thereon. The power supply voltage V_{AN} supplied to the anode of the SPAD 222 is, for example, a negative bias (negative potential) of about −20 V.

An operation of the dToF pixel 201 in FIG. 7 is described.

In order to detect light (photon) with sufficient efficiency, a voltage (excess bias) larger than a breakdown voltage VBD of the SPAD 222 is applied to the SPAD 222. For example, supposing that the breakdown voltage VBD of the SPAD 222 is 20 V and a voltage larger than this by 3 V is applied, the power supply potential Vcc is set to 3 V.

Since the power supply voltage Vcc (for example, 3 V) and the power supply voltage V_{AN} (for example, −20 V) are supplied to the cathode and the anode of the SPAD 222, respectively, a reverse voltage larger than the breakdown voltage VBD (=20 V) is applied to the SPAD 222, so that the SPAD 222 is set to a Geiger mode. In this state, the cathode voltage V_{CA} of the SPAD 222 is the same as the power supply voltage Vcc.

When the photon is incident on the SPAD 222, avalanche multiplication occurs, and a current flows in the SPAD 222. When the current flows in the SPAD 222, the current also flows in the load element 221, and a voltage drop occurs due to a resistance component of the load element 221.

When the cathode voltage V_{CA} of the SPAD 222 becomes lower than 0 V, an anode-cathode voltage of the SPAD 222 becomes lower than the breakdown voltage VBD, so that the avalanche amplification stops. Here, an operation in which the current generated by the avalanche amplification flows in the load element 221 to generate the voltage drop, and the cathode voltage V_{CA} becomes lower than the breakdown voltage VBD along with the generated voltage drop, thereby stopping the avalanche amplification is a quenching operation.

When the avalanche amplification stops, the current flowing in the resistance of the load element 221 gradually decreases, and the cathode voltage V_{CA} returns again to the original power supply voltage Vcc and it is put into a state in which a next new photon may be detected (recharge operation).

The inverter 223 outputs a High detection signal when the voltage drop occurs and the cathode voltage V_{CA} is lower than a predetermined threshold voltage Vth.

The dToF pixel 201 in FIG. 7 has a configuration referred to as a passive recovery (passive recharge) circuit that passively recovers the voltage drop caused by quenching.

Out of the dToF pixel 201 in FIG. 7, the SPAD 222 is arrayed in units of pixels in the SPAD pixel region 112 of the upper substrate 101a, and other circuits, that is, the load element (LOAD element) 221 and the inverter 223 are arrayed in units of pixels in the under-pixel circuit region 122 of the lower substrate 101b.

### Second Configuration Example of dToF Pixel

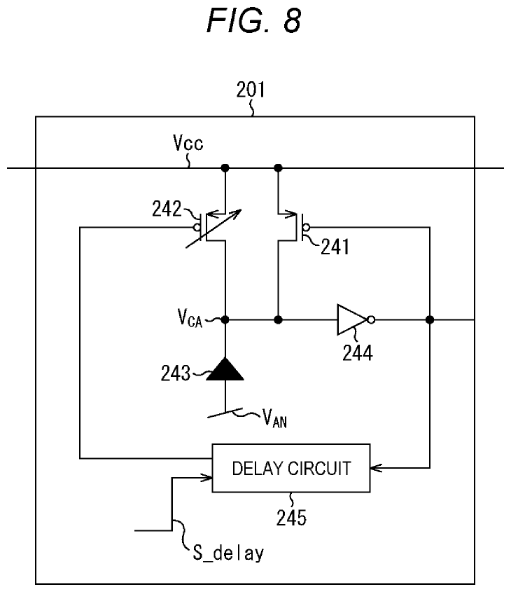

FIG. 8 illustrates a second configuration example of the dToF pixel.

The dToF pixel 201 in FIG. 8 includes P-type MOSFETs 241 and 242, a SPAD 243, an inverter 244, and a delay circuit 245.

More specifically, a source of the MOSFET 241 is connected to the power supply voltage Vcc, a gate thereof is connected to an output terminal of the inverter 244 and an input terminal of the delay circuit 245, and a drain thereof is connected to a cathode of the SPAD 243, a drain of the MOSFET 242, and an input terminal of the inverter 244.

A source of the MOSFET 242 is connected to the power supply voltage Vcc, a gate thereof is connected to an output terminal of the delay circuit 245, and the drain thereof is connected to the cathode of the SPAD 243, the drain of the MOSFET 241, and the input terminal of the inverter 244.

The drain of each of the MOSFETs 241 and 242, and the input terminal of the inverter 244 are connected to the cathode of the SPAD 243, and the power supply voltage V_{AN} is externally applied to an anode thereof.

The drain of each of the MOSFETs 241 and 242 and the cathode of the SPAD 243 are connected to the input terminal of the inverter 244, and the gate of the MOSFET 241 and the input terminal of the delay circuit 245 are connected to the output terminal thereof.

The gate of the MOSFET 241 and the output terminal of the inverter are connected to the input terminal of the delay circuit 245, and the gate of the MOSFET 242 is connected to the output terminal thereof.

The dToF pixel 201 in FIG. 8 has a configuration referred to as an active recovery (active recharge) circuit that actively recovers the voltage drop caused by the quenching. The delay circuit 245 outputs a delay signal to the gate of the MOSFET 242 on the basis of an output of the inverter 244 and an adjustment signal S Delay, thereby actively recovering the voltage drop caused by the quenching.

### Third Configuration Example of dToF Pixel

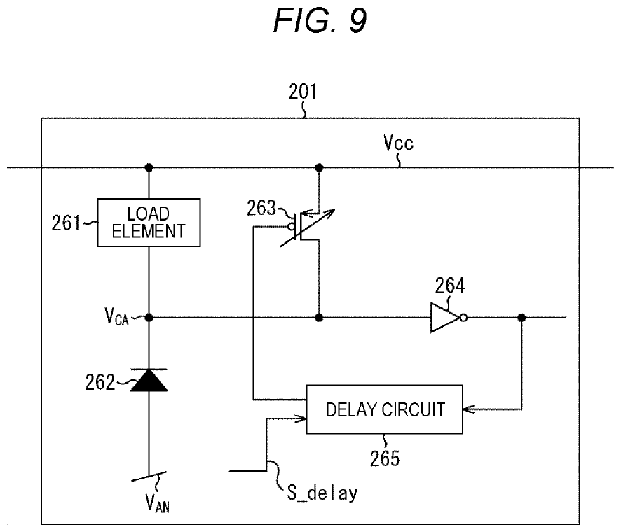

FIG. 9 illustrates a third configuration example of the dToF pixel.

The dToF pixel 201 in FIG. 9 includes a load element (LOAD element) 261, a SPAD 262, a P-type MOSFET 263, an inverter 264, and a delay circuit 265.

More specifically, one terminal of the load element 261 is connected to the power supply voltage Vcc, and the other terminal thereof is connected to a cathode of the SPAD 262, a drain of the MOSFET 263, and an input terminal of the inverter 264.

The other terminal of the load element 261, the drain of the MOSFET 263, and the input terminal of the inverter 223 are connected to the cathode of the SPAD 262, and the power supply voltage V_{AN} is applied to an anode thereof.

A source of the MOSFET 263 is connected to the power supply voltage Vcc, a gate thereof is connected to an output terminal of the delay circuit 265, and a drain thereof is connected to the other terminal of the load element 261, the cathode of the SPAD 262, and the input terminal of the inverter 264.

The input terminal of the inverter 264 is connected to the other terminal of the load element 261, the cathode of the SPAD 262, and the drain of the MOSFET 263, and an output terminal of the inverter 264 is connected to an input terminal of the delay circuit 265.

The input terminal of the delay circuit 265 is connected to the output terminal of the inverter 264, and the output terminal of the delay circuit 265 is connected to the gate of the MOSFET 263.

The dToF pixel 201 in FIG. 9 has another configuration of the active recovery (active recharge) circuit that actively recovers the voltage drop caused by the quenching. The delay circuit 265 outputs a delay signal to the gate of the MOSFET 263 on the basis of an output of the inverter 264 and an adjustment signal S Delay, thereby actively recovering the voltage drop caused by the quenching.

### Fourth Configuration Example of dToF Pixel

FIG. 10 illustrates a fourth configuration example of the dToF pixel.

The dToF pixel 201 in FIG. 10 is a circuit in which the passive recovery circuit and the active recovery circuit are combined to be used in a switching manner.

The dToF pixel 201 in FIG. 10 includes a passive configuration portion 271 and an active configuration portion 272.

The passive configuration portion 271 includes a load element (LOAD element) 281, a switch 282, and a SPAD 283.

The active configuration portion 272 includes P-type MOSFETs 291 and 292, switches 293 and 294, an inverter 295, and a delay circuit 296.

The load element 281 and the SPAD 283 of the passive configuration portion 271 and the inverter 295 of the active configuration portion 272 have configurations corresponding to the load element 221, the SPAD 222, and the inverter 223 in FIG. 7.

Furthermore, the MOSFETs 291 and 292, the inverter 295, and the delay circuit 296 of the active configuration portion 272 have configurations corresponding to the MOSFETs 241 and 242, the inverter 244, and the delay circuit 245 in FIG. 8.

By exclusively turning on and off the switch 282 and the switches 293 and 294, it is possible to switch whether to allow the passive configuration portion 271 to function or the active configuration portion 272 to function.

FIG. 10 illustrates a state in which the switch 282 is turned off and the switches 293 and 294 are turned on, so that the active configuration portion 272 functions. In contrast, in a case where the switch 282 is turned on and the switches 293 and 294 are turned off, it is switched to a state in which the passive configuration portion 271 functions.

### 6. Operation of Ranging Sensor According to First Configuration Example

An operation of the ranging sensor 11 according to the first configuration example illustrated in FIG. 4 will be described.

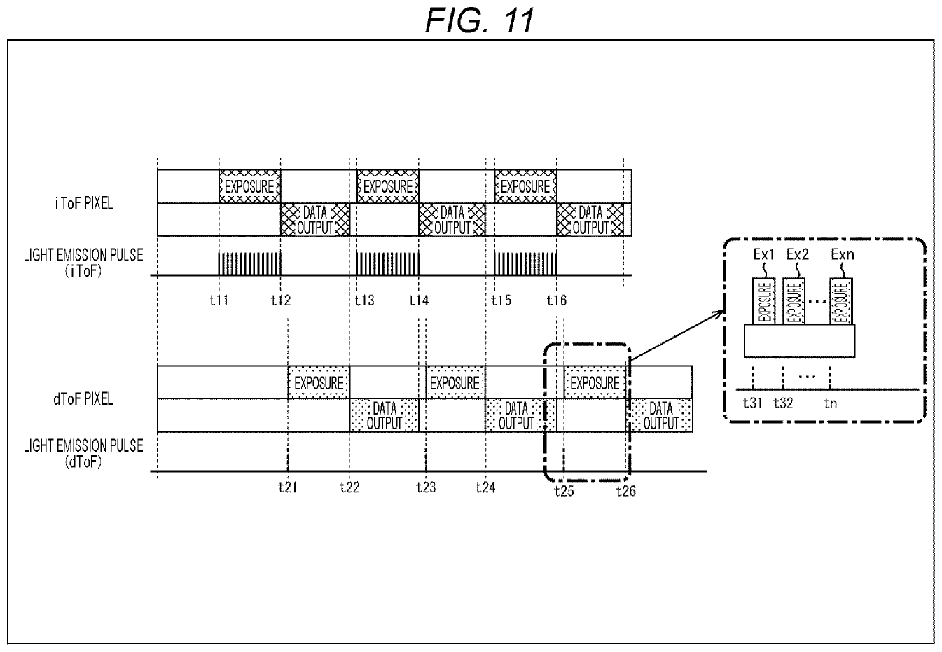

FIG. 11 is a timing chart for illustrating the operation of the ranging sensor 11 according to the first configuration example.

FIG. 11 illustrates timings of exposure and the light emission pulse of each iToF pixel 141 in the iToF pixel region 61 in the iToF ranging, and timings of exposure and the light emission pulse of each dToF pixel 201 in the dToF pixel region 81 in the dToF ranging.

The ranging sensor 11 according to the first configuration example has a configuration in which the ranging sensor of iToF and the ranging sensor of dToF are arranged in a plane direction of one chip. The iToF ranging and the dToF ranging are executed at different timings by time division processing in order to prevent interference.

Supposing that the ranging is performed in the order of the iToF ranging and dToF ranging, first, as illustrated in FIG. 11, the iToF light emission control circuit 43a generates the light emission pulse repeatedly turned on and off at a predetermined frequency from time t11 to time t12, and allows the light emission unit 13 to emit the irradiation light for the iToF ranging.

In response to this, from time t11 to time t12, the iToF pixel 141 in the iToF pixel region 61 performs the exposure for receiving the reflected light. In each iToF pixel 141 in the iToF pixel region 61, the pixel signal corresponding to the amount of received light is accumulated.

Then, when the emission of the irradiation light for the iToF ranging and the exposure of each iToF pixel 141 end at time t12, data processing based on the pixel signal accumulated in each iToF pixel 141 is performed from time t12 to t22, and the ranging data is output.

In contrast, since the emission of the irradiation light for the iToF ranging ends at time t12, the dToF light emission control circuit 43b generates the light emission pulse for the dToF ranging at time t21, a timing immediately after time t12, and allows the light emission unit 13 to emit the irradiation light. In response to this, from time t21 to time t22, the dToF pixel 201 in the dToF pixel region 81 performs the exposure for receiving the reflected light.

Here, the light emission of the irradiation light and the exposure for the dToF ranging executed from time t21 to time t22 are repeatedly executed several times to several hundred times as indicated by a dashed-dotted line on a right side in FIG. 11 for noise countermeasures. In an exposure period indicated by the dashed-dotted line, the light emission pulse is turned on at times t31, t32, . . . , and to at fixed time intervals, and exposures Ex1, Ex2, . . . , and Exn are also repeated corresponding to on periods. Note that, a frequency of the light emission pulse of the irradiation light for the dToF ranging is lower than a frequency of the light emission pulse for the iToF ranging.

Then, when the emission of the irradiation light for the dToF ranging and the exposure of each dToF pixel 201 end at time t22, from time t22 to time t14, the histogram of the count values from the light emission to the light reception is created for each dToF pixel 201, and the ranging data based on a peak value of the histogram is output.

Subsequently, since the emission of the irradiation light for the dToF ranging ends at time t22, the iToF light emission control circuit 43a generates the light emission pulse repeatedly turned on and off at a predetermined frequency at time t13, a timing immediately after time t22, and allows the light emission unit 13 to emit the irradiation light for the iToF ranging.

In response to this, from time t13 to time t14, the iToF pixel 141 in the iToF pixel region 61 performs the exposure for receiving the reflected light. In each iToF pixel 141 in the iToF pixel region 61, the pixel signal corresponding to the amount of received light is accumulated.

Then, when the emission of the irradiation light for the iToF ranging and the exposure of each iToF pixel 141 end at time t14, data processing based on the pixel signal accumulated in each iToF pixel 141 is performed from time t14 to t24, and the ranging data is output.

Moreover, since the emission of the irradiation light for the iToF ranging ends at time t14, the dToF light emission control circuit 43b generates the light emission pulse for the dToF ranging at time t23, a timing immediately after time t14, and allows the light emission unit 13 to emit the irradiation light. In response to this, from time t23 to time t24, the dToF pixel 201 in the dToF pixel region 81 performs the exposure for receiving the reflected light.

Then, when the emission of the irradiation light for the dToF ranging and the exposure of each dToF pixel 201 end at time t24, from time t24 to time t16, the histogram of the count values from the light emission to the light reception is created for each dToF pixel 201, and the ranging data based on a peak value of the histogram is output.

In this manner, the emission of the irradiation light for the iToF ranging and the emission of the irradiation light for the dToF ranging are alternately repeated, and data processing of the iToF ranging is performed and the ranging data is output during a light emission period of the dToF ranging, and data processing of the dToF ranging is performed and the ranging data is output during the light emission period of the iToF ranging.

As described above, according to the first configuration example of the ranging sensor 11, it is possible to perform the ranging by both iToF and dToF for the same ranging range and output the ranging data.

### 7. Second Configuration Example of Ranging Sensor

<Plan View>

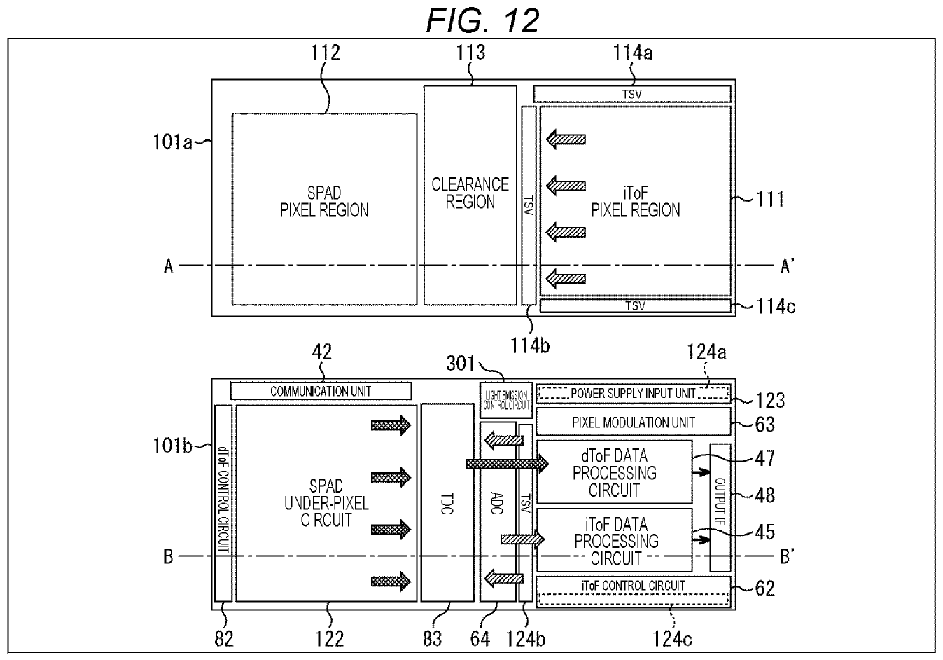

FIG. 12 is a plan view depicting a second configuration example of each substrate of the ranging sensor 11.

In FIG. 12, a portion corresponding to that in the first configuration example illustrated in FIG. 4 is assigned with the same reference sign and the detailed description thereof is omitted.

In the first configuration example illustrated in FIG. 4, on the lower substrate 101b, the circuit for the iToF ranging is arranged under the iToF pixel region 111 of the upper substrate 101a on the right side in FIG. 4, and the circuit for the dToF ranging is arranged under the SPAD pixel region 112 and the clearance region 113 of the upper substrate 101a.

In the second configuration example in FIG. 12, on the lower substrate 101b, the arrangement is made more efficient regardless of whether the ranging is the dToF ranging or the iToF ranging.

As compared with the first configuration example illustrated in FIG. 4, on the upper substrate 101a, a position of the TSV region 114b is changed from the right side to the left side of the iToF pixel region 111, and is arranged between the iToF pixel region 111 and the clearance region 113.

On the lower substrate 101b, in the first configuration example in FIG. 4, the light emission control circuit 43 is arranged in a manner divided into the iToF light emission control circuit 43a that generates the light emission pulse in a case of performing the iToF ranging, and the dToF light emission control circuit 43b that generates the light emission pulse in a case of performing the dToF ranging; however, in the second configuration example, this is made one light emission control circuit 43 and is arranged adjacent to the power supply input unit 123. The light emission control circuit 43 generates the light emission pulse for the iToF ranging and the light emission pulse for the irradiation light for the dToF ranging in a time division manner to output.

Furthermore, the position of the TSV region 124b is changed to a position corresponding to the TSV region 114b of the upper substrate 101a, and the ADC 64 is arranged between the TSV region 124b and the TDC 83. A position of the iToF control circuit 62 is changed to the position of the TSV region 124c. The iToF data processing circuit 45 and the dToF data processing circuit 47 are arranged in an inner region surrounded by the iToF control circuit 62, the ADC 64, the pixel modulation unit 63, and the output IF 48.

Each circuit arrangement other than this of the second configuration example in FIG. 12 is similar to that of the first configuration example illustrated in FIG. 4.

The drive signal of reset of the charge of each iToF pixel, reading of the pixel signal and the like is supplied from the iToF control circuit 62 to each iToF pixel in the iToF pixel region 61 of the upper substrate 101a via the TSV region 124c and the TSV region 114c.

The pixel signal generated by each iToF pixel in the iToF pixel region 111 is transferred in a lateral direction indicated by hatched arrows and supplied to the ADC 64 via the TSV region 114b and the TSV region 124b. Then, after the pixel signal is AD-converted by the ADC 64, this is transferred to the iToF data processing circuit 45, and the distance to the object is calculated by the iToF data processing circuit 45 to be output from the output IF 48.

In contrast, the signal generated by each dToF pixel in the SPAD pixel region 112 is transferred to the under-pixel circuit region 122 by Cu—Cu junction and the like, transferred in a lateral direction indicated by cross-hatched arrows in the under-pixel circuit region 122, and supplied to the TDC 83. Then, by the TDC 83, the count value corresponding to the flight time from the light emission to the light reception is generated and supplied to the dToF data processing circuit 47. By the dToF data processing circuit 47, the distance to the subject is calculated for each pixel by generating the histogram of the count values, and is output from the output IF 48.

By arranging the TDC 83 adjacent to the under-pixel circuit region 122, the signal generated by each dToF pixel in the under-pixel circuit region 122 may be immediately supplied to the TDC 83, and a wiring delay may be minimized. Note that, a transmission time error (wiring delay error) due to a pixel position in the lateral direction of each dToF pixel in the under-pixel circuit region 122 is adjusted by calibration and the like, and the error in the longitudinal direction is guaranteed in order of several tens to several hundreds of picoseconds (ps).

The pixel modulation unit 63 and the power supply input unit 123 of the lower substrate 101b are arranged adjacent to the iToF pixel region 111 of the upper substrate 101a at the shortest distance via the TSV region 124a and the TSV region 114a. As described above, the pixel modulation unit 63 controls the first voltage GDA and the second voltage GDB that drive the first tap and the second tap, respectively, of the iToF pixel 141. Therefore, since a special voltage different from a drive control signal for driving the transistor is required and the power is large, the pixel modulation unit 63 is arranged adjacent to the power supply input unit 123. The first voltage GDA and the second voltage GDB of the power supply input unit 123 are transmitted to the upper substrate 101a via the TSV region 124a and the TSV region 114a, and are supplied to each iToF pixel in the iToF pixel region 111. Furthermore, since wiring of the first voltage GDA and the second voltage GDB is required in units of pixel columns of the iToF pixel region 111, in order to secure a large number of contacts between the pixel modulation unit 63 and the power supply input unit 123, long sides of rectangular regions of the pixel modulation unit 63 and the power supply input unit 123 are arranged adjacent to each other. The power supply input unit 123 is arranged at a peripheral end of the lower substrate 101b.

The light emission control circuit 43 needs to output a high-frequency light emission pulse to the LD 12 in both the iToF ranging and the dToF ranging. Furthermore, the emission of the irradiation light in the light emission unit 13 and switching between the first tap and the second tap of the iToF pixel need to be synchronized in units of nanoseconds (ns). Furthermore, it is necessary to suppress an influence of a temperature change and the like in a peripheral portion and minimize the wiring delay. Therefore, the light emission control circuit 43 is desirably arranged closely adjacent to the pixel modulation unit 63.

In contrast, the TDC 82 that counts the time from the light emission of the light emission unit 13 to the reception of the reflected light needs to be matched with the light emission pulse that controls the light emission timing of the light emission control circuit 43 in the order of about one hundred picoseconds (ps). Then, it is necessary to suppress an influence of a temperature change and the like in the peripheral portion and minimize the wiring delay. Therefore, the TDC 82 is desirably arranged closely adjacent to the light emission control circuit 43.

For the above-described reason, on the lower substrate 101b, the light emission control circuit 43 is arranged adjacent to both the pixel modulation unit 63 and the TDC 83 as illustrated in the plan view in FIG. 12. Therefore, it becomes possible to control signals of which high-speed control is required that require timing care with high accuracy.

<Cross-Sectional View>

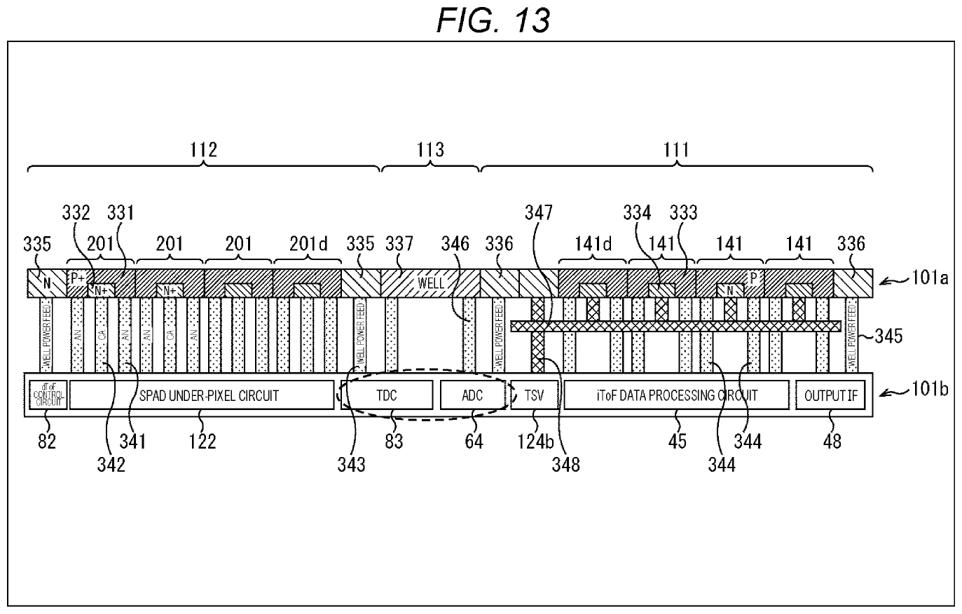

FIG. 13 is a view depicting a simplified cross-sectional configuration taken along line A-A′ on the upper substrate 101a and line B-B′ on the lower substrate 101b in FIG. 12.

On the upper substrate 101a, a plurality of dToF pixels 201 is arrayed in the SPAD pixel region 112, and a dummy dToF pixel 201d is arranged at a boundary on the clearance region 113 side. The dummy dToF pixel 201d is a pixel having the same structure as that of the dToF pixel 201 that does not perform a drive operation, or a pixel that obtains a reference voltage by performing the same drive.

In the iToF pixel region 111 of the upper substrate 101a, a plurality of iToF pixels 141 is arrayed, and a dummy iToF pixel 141d is arranged at a boundary on the clearance region 113 side. The dummy iToF pixel 141d is a pixel having the same structure as that of the iToF pixel 141 that does not perform a drive operation, or a pixel that obtains a reference voltage by performing the same drive.

By collectively arranging the dToF pixels 201 in the SPAD pixel region 112, and collectively arranging the iToF pixels 141 in the iToF pixel region 111 instead of alternately arranging the dToF pixels 201 and the iToF pixels 141, they may be efficiently arranged. A region width of the clearance region 113 between the iToF pixel region 111 and the SPAD pixel region 112 is made, for example, about 200 to 300 μm.

As described above, only the SPAD portion of the dToF pixel 201 is formed in the SPAD pixel region 112 of the upper substrate 101a. In FIG. 13, a P-type region 331 serving as a hole accumulation layer and an N-type region 332 in which electrons are accumulated are illustrated. Wiring 341 for supplying the anode voltage V_{AN} (for example, −20 V) is connected to the P-type region 331 from the lower substrate 101b, and wiring 342 for supplying the cathode voltage V_{CA} (for example, 3 V) is connected to the N-type region 332 from the lower substrate 101b. An N well 335 in the SPAD pixel region 112 is controlled to 3 V via wiring 343, for example.

In the iToF pixel 141 in the iToF pixel region 111, a P-type region 333 and an N-type region 334 forming a photodiode are illustrated. The P-type region 333 is controlled to −3 V via wiring 344, for example. An N well 336 in the iToF pixel region 111 is controlled to 3 V via wiring 345, for example. The pixel signals generated by the iToF pixels 141 in the same column arrayed in the lateral direction of the iToF pixel region 111 are transmitted through a vertical signal line 347 arranged in a column direction and passed from a TSV 348 in the TSV region 124b to the lower substrate 101b.

In the clearance region 113 of the upper substrate 101a, a well region 337 controlled to 0 V via wiring 346 is arranged. Since the voltages used in the iToF pixel region 111 and the SPAD pixel region 112 are different from each other, the iToF pixel region 111 and the SPAD pixel region 112 are electrically separated from each other by the well region 337 of 0 V. Note that, it is possible to separate by an oxide film in place of the well region 337.

The TDC 83 and the ADC 64 are arranged in a region indicated by a dashed ellipse of the lower substrate 101b under the clearance region 113. In this manner, by arranging a predetermined circuit in a region under the clearance region 113 of the lower substrate 101b, an area of the lower substrate 101b may be effectively utilized.

According to the arrangement of the respective substrates according to the second configuration example described above, it is possible to efficiently arrange circuits that implement the ranging by different ranging methods of iToF and dToF.

### 8. Third Configuration Example of Ranging Sensor

<Plan View>

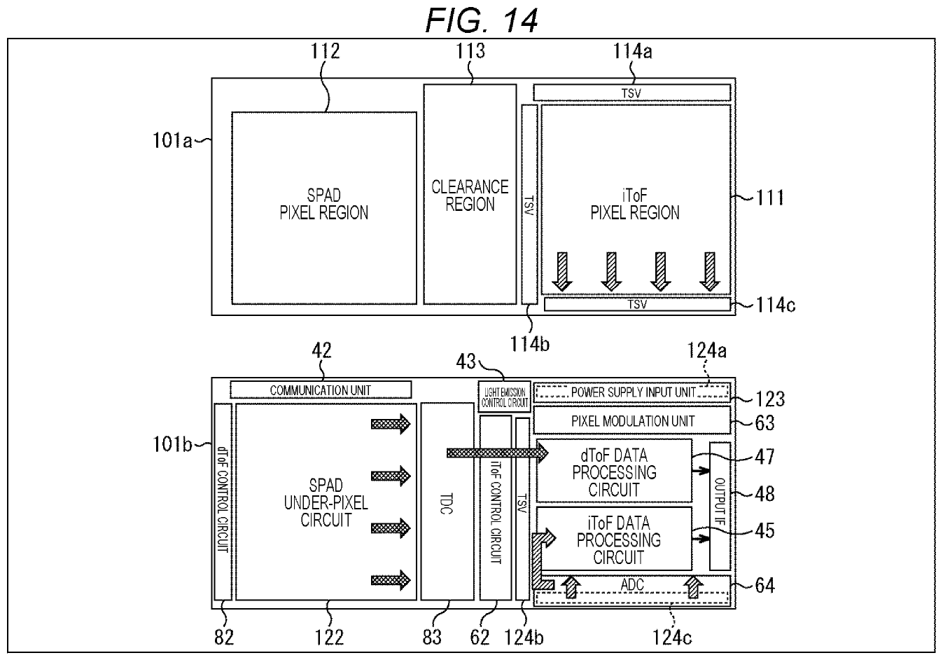

FIG. 14 is a plan view depicting a third configuration example of each substrate of the ranging sensor 11.

In FIG. 14, a portion corresponding to that in the second configuration example illustrated in FIG. 12 is assigned with the same reference sign and the detailed description thereof is omitted.

Comparing the third configuration example in FIG. 14 with the second configuration example illustrated in FIG. 12, arrangement of the iToF control circuit 62 and the ADC 64 of the lower substrate 101b is switched.

In a case of such arrangement, a drive signal of reset of the charge of each iToF pixel 141, reading of the pixel signal and the like is supplied from the iToF control circuit 62 to each iToF pixel 141 in the iToF pixel region 61 of the upper substrate 101a via the TSV region 124b and the TSV region 114b.

Furthermore, the pixel signal generated by each iToF pixel 141 in the iToF pixel region 111 is transferred in the longitudinal direction indicated by hatched arrows and supplied to the ADC 64 via the TSV region 114c and the TSV region 124c. Then, after the pixel signal is AD-converted by the ADC 64, this is transferred to the iToF data processing circuit 45, and the distance to the object is calculated by the iToF data processing circuit 45 to be output from the output IF 48.

For example, in a case where circuit areas of the TDC 83 and the ADC 64 are large and they cannot be arranged in a region under the clearance region 113 of the upper substrate 101a, they may be arranged as in FIG. 14.

In the third configuration example in FIG. 14 also, an arrangement relationship among the light emission control circuit 43, the pixel modulation unit 63, the power supply input unit 123, and the TDC 83 is similar to that in the second configuration example in FIG. 12. That is, the pixel modulation unit 63 and the power supply input unit 123 of the lower substrate 101b are arranged adjacent to the iToF pixel region 111 of the upper substrate 101a at the shortest distance. The light emission control circuit 43 is arranged adjacent to both the pixel modulation unit 63 and the TDC 83. Therefore, it becomes possible to control signals of which high-speed control is required that require timing care with high accuracy.

According to the arrangement of the respective substrates according to the third configuration example described above, it is possible to efficiently arrange circuits that implement the ranging by different ranging methods of iToF and dToF.

### 9. Fourth Configuration Example of Ranging Sensor

<Plan View>

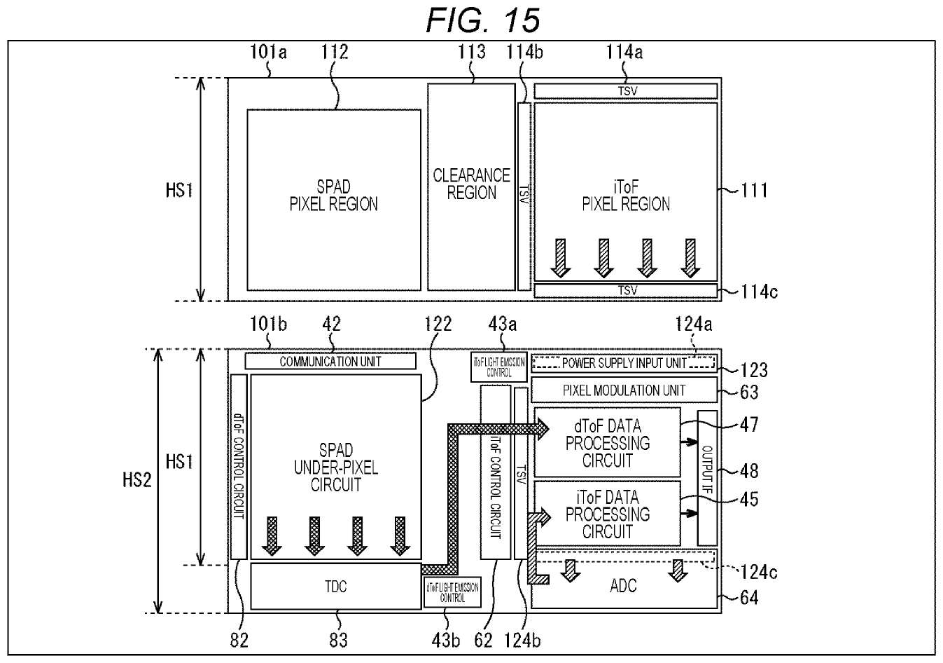

FIG. 15 is a plan view depicting a fourth configuration example of each substrate of the ranging sensor 11.

In FIG. 15, a portion corresponding to that in the first to third configuration examples described above is assigned with the same reference sign and the detailed description thereof is omitted.

In the ranging system 1 in FIG. 1, on the premise that there is one light emission unit 13, both the light emission at the time of the iToF ranging and the light emission at the time of the dToF ranging are controlled by one light emission control circuit 43, thereby implementing a cost reduction by sharing.

However, a case where the light emission unit 13 is separately provided for the dToF and iToF and the like is also considered; for example, light emission intensity of the light source is designed to be large in the dToF in order to be able to measure a relatively long distance. In a case where the light emission unit 13 is separately provided in the dToF and iToF in this manner, the light emission control circuit 43 may also adopt a configuration in which the iToF light emission control circuits 43a and 43b are separately arranged as in the first configuration example.

Furthermore, with miniaturization of the pixel, a transistor size increases in proportion to the pixel, and it might be necessary to secure a large circuit area of the TDC 83, the ADC 64 and the like.

The fourth configuration example illustrated in FIG. 15 illustrates a configuration example of each substrate in a case where a large circuit area of the TDC 83, the ADC 64 and the like is secured, and the light emission unit 13 is separately provided for the dToF and iToF.

In the fourth configuration example, a size HS2 of a short side of the lower substrate 101b is made larger than a size HS1 of a short side of the upper substrate 101a (HS1<HS2), and the lower substrate 101b is made larger than the upper substrate 101a. Then, the TDC 83 and the ADC 64 are arranged in an area larger than that of the first to third configuration examples described above in a portion obtained by increasing the area of the substrate.

Furthermore, in the fourth configuration example, as in the first configuration example illustrated in FIG. 4, the iToF light emission control circuit 43a that generates the light emission pulse in a case of performing the iToF ranging, and the dToF light emission control circuit 43b that generates the light emission pulse in a case of performing the dToF ranging are separately provided. The iToF light emission control circuit 43a is arranged at a position adjacent to the pixel modulation unit 63 and the power supply input unit 123, and the dToF light emission control circuit 43b is arranged at a position adjacent to the TDC 83.

In the fourth configuration example in FIG. 15, the iToF light emission control circuit 43a is arranged adjacent to the pixel modulation unit 63 and the power supply input unit 123. Therefore, it becomes possible to control signals of which high-speed control is required that require timing care with high accuracy. Furthermore, the long sides of the rectangular regions of the pixel modulation unit 63 and the power supply input unit 123 are arranged adjacent to each other. Therefore, it is possible to secure a large number of contacts with the power supply input unit 123 of the pixel modulation unit 63 that requires a special voltage and has large power.

Furthermore, the dToF light emission control circuit 43b is arranged at a position adjacent to the TDC 83. Therefore, it becomes possible to control signals of which high-speed control is required that require timing care with high accuracy.

According to the arrangement of the respective substrates according to the fourth configuration example described above, it is possible to efficiently arrange circuits that implement the ranging by different ranging methods of iToF and dToF.

### 10. Fifth Configuration Example of Ranging Sensor

<Plan View>

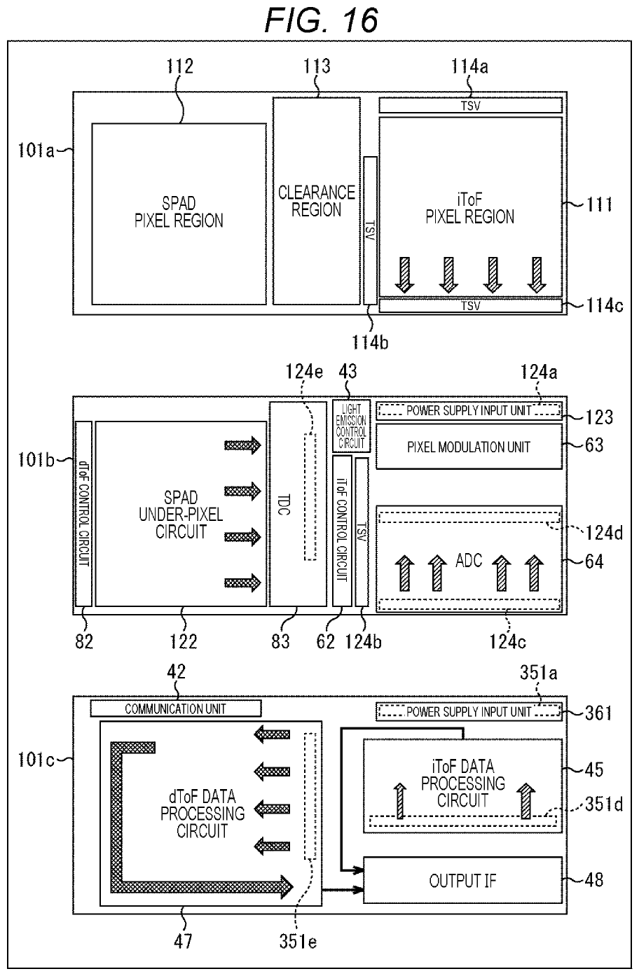

FIG. 16 is a plan view depicting a fifth configuration example of each substrate of the ranging sensor 11.

In FIG. 16, a portion corresponding to that in the first to fourth configuration examples described above is assigned with the same reference sign and the detailed description thereof is omitted.

The fifth configuration example illustrated in FIG. 16 illustrates a configuration example in a case where the ranging sensor 11 is formed by stacking three semiconductor substrates. In the example in FIG. 16, in addition to the first semiconductor substrate 101a and the second semiconductor substrate 101b described above, a third semiconductor substrate 101c is further added. In a case where the ranging sensor 11 has a stacked structure of three semiconductor substrates, for example, the first semiconductor substrate 101a is an uppermost layer (light receiving surface), the second semiconductor substrate 101b is an intermediate layer, and the third semiconductor substrate 101c is a lowermost layer. Then, hereinafter, the first semiconductor substrate 101a is referred to as an upper substrate 101a, the second semiconductor substrate 101b is referred to as a middle substrate 101b, and the third semiconductor substrate 101c is referred to as a lower substrate 101c.

On the lower substrate 101c, the communication unit 42, the iToF data processing circuit 45, the dToF data processing circuit 47, the output IF 48, and a power supply input unit 361 are arranged.

The power supply input unit 361 includes a TSV region 351a corresponding to the TSV region 124a of the middle substrate 101b, and supplies a predetermined power supply voltage input from the external substrate to the middle substrate 101b. A TSV region 351d in which a through silicon via electrically connected to the middle substrate 101b is arranged is arranged at a predetermined position of the iToF data processing circuit A TSV region 351e in which a through silicon via electrically connected to the middle substrate 101b is arranged is arranged at a predetermined position of the dToF data processing circuit 47.

Since the iToF data processing circuit 45, the dToF data processing circuit 47 and the like are moved to the lower substrate 101c, the ADC 64, the TDC 83 and the like are arranged with a wide circuit area on the middle substrate 101b. In the ADC 64, in addition to the TSV region 124c, a TSV region 124d is provided at a position corresponding to the TSV region 351d of the lower substrate 101c. Furthermore, in the TDC 83, a TSV region 124e is provided at a position corresponding to the TSV region 351e of the lower substrate 101c.

In the ranging sensor 11 in the fifth configuration example arranged in the above-described manner, the pixel signal generated by each iToF pixel in the iToF pixel region 111 is transferred by a longitudinal direction indicated by hatched arrows and supplied to the ADC 64 via the TSV region 114c and the TSV region 124c. Then, after the pixel signal is AD-converted by the ADC 64, this is transmitted to the iToF data processing circuit 45 via the TSV region 124d and the TSV region 351d. Then, the distance to the object is calculated by the iToF data processing circuit 45 and output from the output IF 48.

In contrast, the signal generated by each dToF pixel in the SPAD pixel region 112 is transferred to the under-pixel circuit region 122 by Cu—Cu junction and the like, transferred in a lateral direction indicated by cross-hatched arrows in the under-pixel circuit region 122, and supplied to the TDC 83. Then, by the TDC 83, the count value corresponding to the flight time from the light emission to the light reception is generated and supplied to the dToF data processing circuit 47 via the TSV region 124e and the TSV region 351e. By the dToF data processing circuit 47, the distance to the subject is calculated for each pixel by generating the histogram of the count values, and is output from the output IF 48.

In the fifth configuration example illustrated in FIG. 16 also, on the middle substrate 101b on a second layer, the light emission control circuit 43 is arranged adjacent to both the pixel modulation unit 63 and the TDC 83. Therefore, it becomes possible to control signals of which high-speed control is required that require timing care with high accuracy.

By concentrating logic circuits such as the iToF data processing circuit 45 and the dToF data processing circuit 47 on the lower substrate 101c on a third layer, a circuit may be formed by a miniaturization process using a low-k material as for the lower substrate 101c. On the contrary, the middle substrate 101b on the second layer may be formed without using the low-k material.

Furthermore, by arranging the pixel modulation unit 63, the TDC 83 and the like on the second layer and arranging the output IF 48 on the third layer, the output IF 48 susceptible to the influence of power fluctuation may be arranged apart from the pixel modulation unit 63 and the TDC 83.

Note that, the circuit arrangement of the second and third layers including the arrangement of the TSV region in a case where the ranging sensor 11 has a stacked structure of three semiconductor substrates is merely an example, and this may be another circuit arrangement. For example, a part of the circuits of the pixel modulation unit 63 and the TDC 83, for example, a circuit that does not require high-speed operation on the ps or ns order may be arranged on the third layer.

According to the arrangement of the respective substrates according to the fifth configuration example described above, it is possible to efficiently arrange circuits that implement the ranging by different ranging methods of iToF and dToF.

### 11. Sixth Configuration Example of Ranging Sensor

<Plan View>

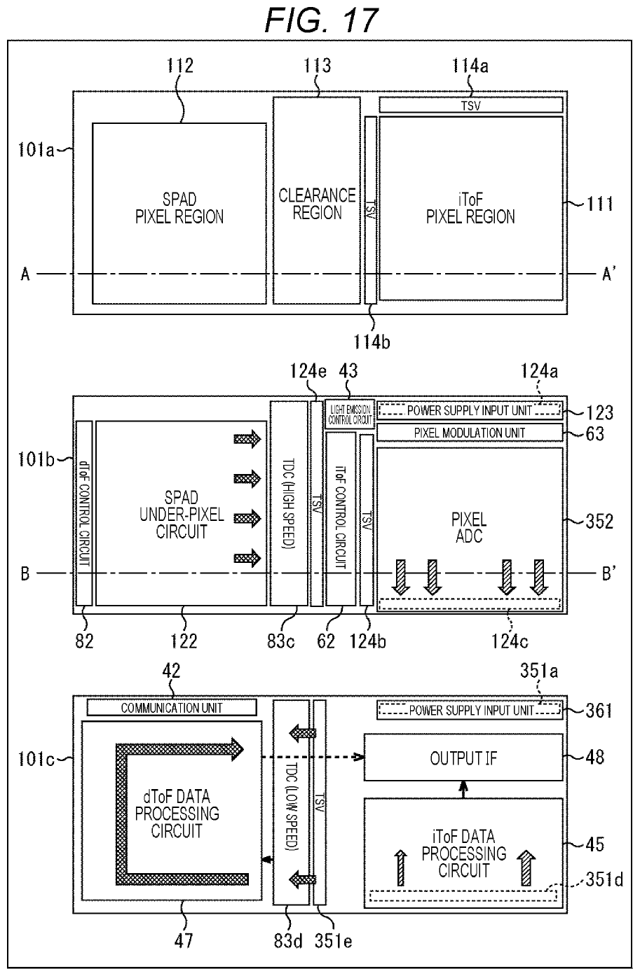

FIG. 17 is a plan view depicting a sixth configuration example of each substrate of the ranging sensor 11.

In FIG. 17, a portion corresponding to that in the first to fifth configuration examples described above is assigned with the same reference sign and the detailed description thereof is omitted.

The sixth configuration example illustrated in FIG. 17 illustrates a configuration example in a case where the ranging sensor 11 is formed by stacking three semiconductor substrates as in the fifth configuration example illustrated in FIG. 16.

Furthermore, in the sixth configuration example illustrated in FIG. 17, a configuration of the column ADC in which the ADC that performs the AD conversion of the pixel signal in the iToF ranging is arranged in units of columns is changed to a configuration of the pixel ADC in which the ADC is arranged for each pixel or in units of a plurality of adjacent M×N pixels (M, N>1).

A configuration of the upper substrate 101a in FIG. 17 is similar to that of the upper substrate 101a in the fifth configuration example illustrated in FIG. 16 except that the TSV region 114c is omitted.

On the middle substrate 101b, a pixel ADC region 352 that performs the pixel ADC is arranged under the iToF pixel region 111 of the upper substrate 101a. The pixel ADC region 352 includes the TSV region 124c. Furthermore, a TDC 83c, which is a partial circuit of the TDC 83, the TSV region 124e, and the iToF control circuit 62 are arranged under the clearance region 113 of the upper substrate 101a. The TDC 83c corresponds to a circuit (high-speed circuit) that performs a high-speed operation requiring timing control of several hundred ps among all the circuits of the TDC 83. For example, the TDC 83c may be a circuit that counts lower four bits of a counter and the like.

On the lower substrate 101c, the communication unit 42, the iToF data processing circuit 45, the dToF data processing circuit 47, the output IF 48, a TDC 83d, the TSV region 351e, and the power supply input unit 361 are arranged.

The TDC 83d is a circuit portion other than the TDC 83c arranged on the second layer among all the circuits of the TDC 83, and corresponds to a circuit (low-speed circuit) that performs a low-speed operation. For example, the TDC 83d may be a circuit that counts upper four bits of a counter and the like.

The TSV region 351e is arranged at a position corresponding to the TSV region 124e of the middle substrate 101b, and the TSV region 351d formed at a predetermined position of the iToF data processing circuit 45 is arranged at a position corresponding to the TSV region 124c of the middle substrate 101b.

In the ranging sensor 11 in the sixth configuration example arranged as described above, the pixel signal generated by each iToF pixel 141 in the iToF pixel region 111 is transferred to the pixel ADC 352 of the middle substrate 101b by Cu—Cu junction and the like, and the AD conversion is performed thereon. Then, the pixel signal on which the AD conversion is performed is transmitted to the iToF data processing circuit 45 of the lower substrate 101c via the TSV region 124c and the TSV region 351d. Then, the distance to the object is calculated by the iToF data processing circuit 45 and output from the output IF 48.

In contrast, the signal generated by each dToF pixel 201 in the SPAD pixel region 112 is transferred to the under-pixel circuit region 122 of the middle substrate 101b by Cu—Cu junction and the like, transferred in the lateral direction indicated by cross-hatched arrows in the under-pixel circuit region 122, and supplied to the TDC 83c. Then, the count value corresponding to the flight time from the light emission to the light reception is generated by combining the high-speed circuit of the TDC 83c and the low-speed circuit of the TDC 83d of the lower substrate 101c connected thereto via the TSV region 124e and the TSV region 351e, and supplied to the dToF data processing circuit 47. By the dToF data processing circuit 47, the distance to the subject is calculated for each pixel by generating the histogram of the count values, and is output from the output IF 48.

<Cross-Sectional View>

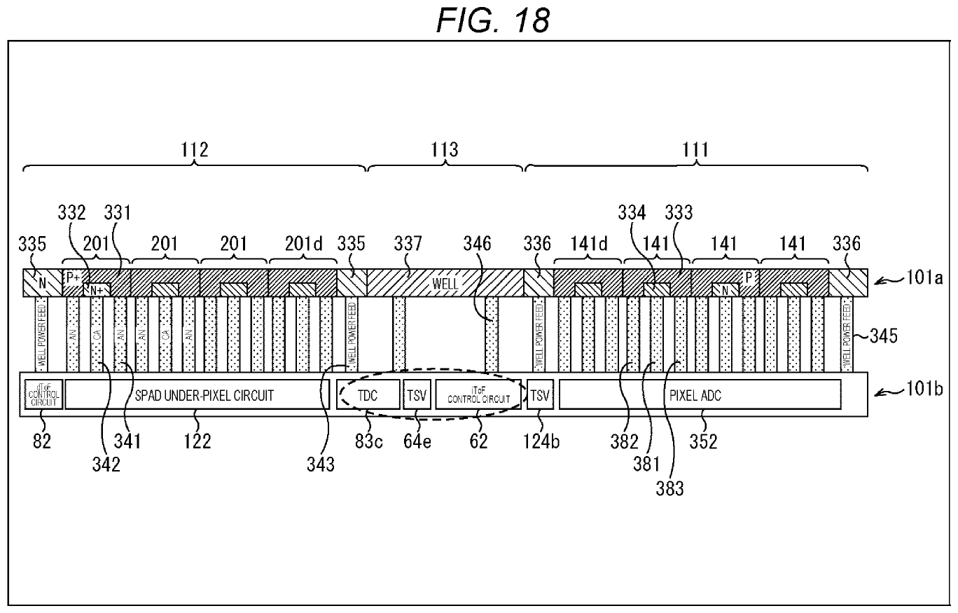

FIG. 18 is a view depicting a simplified cross-sectional configuration taken along line A-A′ on the upper substrate 101a and line B-B′ on the middle substrate 101b in FIG. 17.

In FIG. 18, a portion corresponding to that in the cross-sectional view of the second configuration example illustrated in FIG. 13 is assigned with the same reference sign and the detailed description thereof is omitted.

In the sixth configuration example in FIG. 18, since the pixel ADC region 352 is arranged in the region of the middle substrate 101b under the iToF pixel region 111 of the upper substrate 101a, the vertical signal line 347 arranged in units of columns is omitted, and wiring 381 to wiring 383 connected to the iToF pixel 141 of the upper substrate 101a in units of pixels is provided.

In the clearance region 113 of the upper substrate 101a, a well region 337 controlled to 0 V via wiring 346 is arranged. Since the voltages used in the iToF pixel region 111 and the SPAD pixel region 112 are different from each other, the iToF pixel region 111 and the SPAD pixel region 112 are electrically separated from each other by the well region 337 of 0 V. Note that, it is possible to separate by an oxide film in place of the well region 337.

Furthermore, in the sixth configuration example also, the TDC 83c, the iToF control circuit 62 and the like are arranged in the region of the middle substrate 101b indicated by a dashed ellipse under the clearance region 113 of the upper substrate 101a. In this manner, by arranging a predetermined circuit in a region under the clearance region 113 of the middle substrate 101b, an area of the middle substrate 101b may be effectively utilized.

According to the arrangement of the respective substrates according to the sixth configuration example described above, it is possible to efficiently arrange circuits that implement the ranging by different ranging methods of iToF and dToF.

### 12. Configuration Example of Light Emission Control Circuit

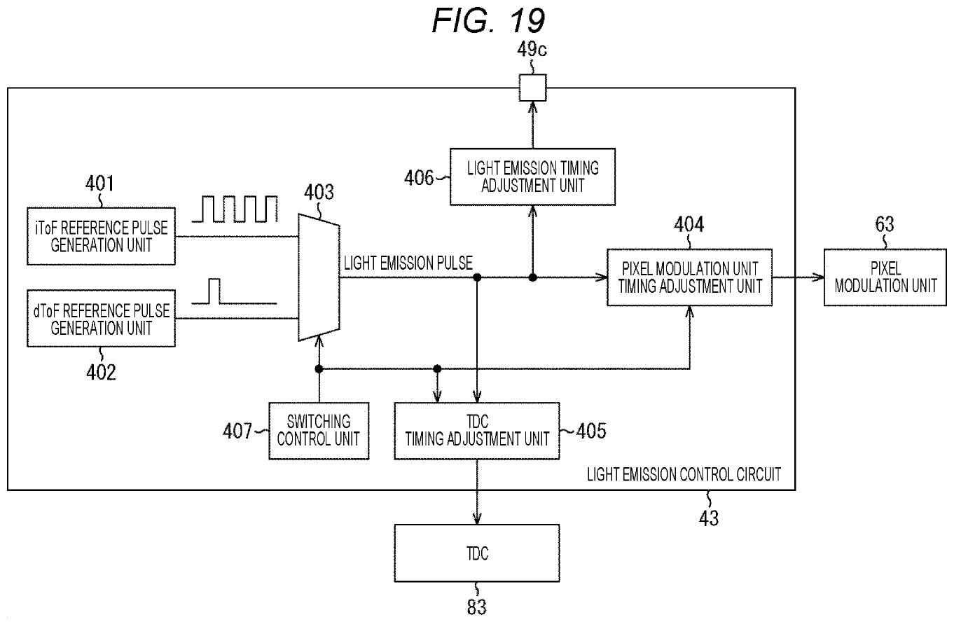

FIG. 19 illustrates a detailed configuration example in a case where the light emission control circuit 43 is shared by the iToF ranging and the dToF ranging, for example, as in the second configuration example described above.

The light emission control circuit 43 includes an iToF reference pulse generation unit 401, a dToF reference pulse generation unit 402, a selector 403, a pixel modulation unit timing adjustment unit 404, a TDC timing adjustment unit 405, a light emission timing adjustment unit 406, and a switching control unit 407.

The iToF reference pulse generation unit 401 generates a reference pulse at the time of performing the iToF ranging, and supplies the same to the selector 403. The dToF reference pulse generation unit 402 generates a reference pulse at the time of performing the dToF ranging, and supplies the same to the selector 403. The selector 403 selects any one of the reference pulse generated by the iToF reference pulse generation unit 401 or the dToF reference pulse generation unit 402 on the basis of a selection control signal from the switching control unit 407, and supplies the same as the light emission pulse to the pixel modulation unit timing adjustment unit 404, the TDC timing adjustment unit 405, and the light emission timing adjustment unit 406.

The pixel modulation unit timing adjustment unit 404 adjusts an output timing (phase) of the light emission pulse supplied from the selector 403 and supplies the same to the pixel modulation unit 63. The TDC timing adjustment unit 405 adjusts an output timing (phase) of the light emission pulse supplied from the selector 403 and supplies the same to the TDC 83. The light emission timing adjustment unit 406 adjusts an output timing (phase) of the light emission pulse supplied from the selector 403 and supplies the same to the LD 12 via the input/output terminal 49c.

The pixel modulation unit 63 and the TDC 83 are arranged adjacent to the light emission control circuit 43 as described above, arranged with a short wiring length, and physically arranged such that a delay amount between the light emission control circuit 43 and the pixel modulation unit 63 and a delay amount between the light emission control circuit 43 and the TDC 83 are the same. Therefore, an influence of the delay due to a process difference, a temperature influence and the like is suppressed. Note that, in a case where slight adjustment is necessary, the output timing of the light emission pulse may be adjusted by the pixel modulation unit timing adjustment unit 404, the TDC timing adjustment unit 405, and the light emission timing adjustment unit 406. Each of the pixel modulation unit timing adjustment unit 404 and the TDC timing adjustment unit 405 adjusts the output timing necessary only for the iToF ranging or the dToF ranging, and the light emission timing adjustment unit 406 adjusts the output timing regardless of whether the ranging is the iToF ranging or the dToF ranging.

By including respective adjustment units of the pixel modulation unit timing adjustment unit 404, the TDC timing adjustment unit 405, and the light emission timing adjustment unit 406 on a subsequent stage of the selector 403, it is possible to avoid a difference between the respective reference pulses due to a circuit, a wiring distance and the like from each reference pulse generation unit to the selector 403.

Furthermore, the switching control unit 407 controls any one of the pixel modulation unit 63 or the TDC 83 to be in a standby state according to whether the ranging to be executed is the iToF ranging or the dToF ranging.

Specifically, the switching control unit 407 also supplies the selection control signal for selecting the iToF ranging or the dToF ranging to the pixel modulation unit timing adjustment unit 404 and the TDC timing adjustment unit 405. In a case where the selection control signal for selecting the dToF ranging is supplied from the switching control unit 407, the pixel modulation unit timing adjustment unit 404 controls itself (pixel modulation unit timing adjustment unit 404) and the pixel modulation unit 63 to be in the standby state. In a case where the selection control signal for selecting the iToF ranging is supplied from the switching control unit 407, the TDC timing adjustment unit 405 controls itself (TDC timing adjustment unit 405) and the TDC 83 to be in the standby state.

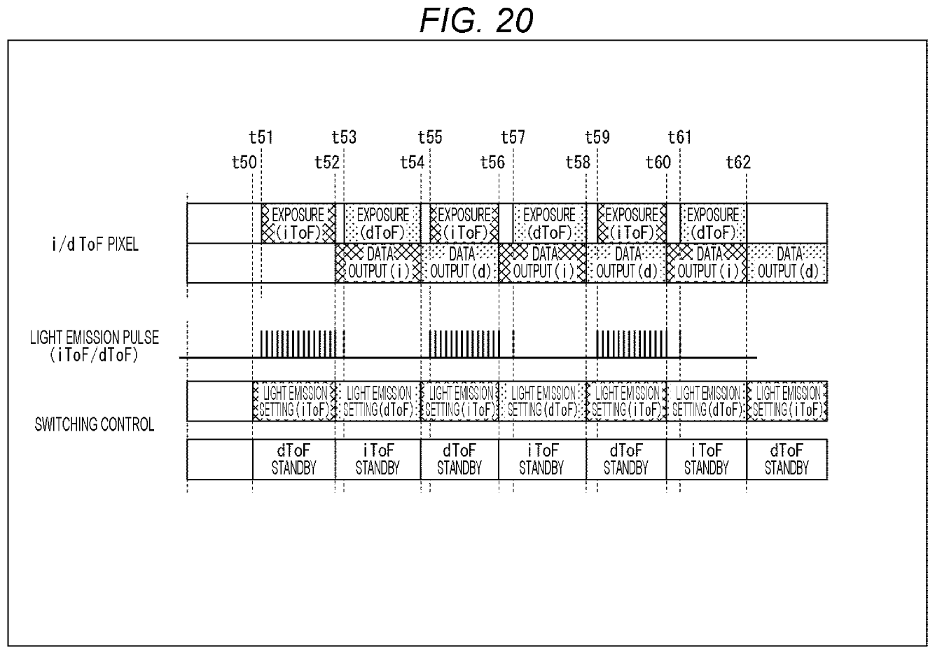

An operation of the light emission control circuit 43 in FIG. 19, and a light emitting operation and a light receiving operation corresponding to the same are described with reference to a timing chart in FIG. 20.

FIG. 20 illustrates timings of exposure and the light emission pulse of each iToF pixel 141 in the iToF pixel region 61 in the iToF ranging, and timings of exposure and the light emission pulse of each dToF pixel 201 in the dToF pixel region 81 in the dToF ranging.

The iToF ranging and the dToF ranging are executed at different timings by time division processing in order to prevent interference.

At time t50, the switching control unit 407 switches light emission setting to the iToF ranging. That is, the switching control unit 407 supplies the selection control signal for selecting the iToF ranging to the selector 403, the pixel modulation unit timing adjustment unit 404, and the TDC timing adjustment unit 405. Therefore, from time t50 to time t52, the selector 403 selects and outputs the reference pulse from the iToF reference pulse generation unit 401 as the light emission pulse, and the TDC timing adjustment unit 405 and the TDC 83 are set to the standby state.

Furthermore, from time t51 to time t52, the light emission timing adjustment unit 406 outputs the light emission pulse for the iToF ranging supplied from the selector 403 to the LD 12. The pixel modulation unit 63 performs the exposure on the basis of the light emission pulse supplied from the pixel modulation unit timing adjustment unit 404, and supplies the pixel signal corresponding to the amount of received light to the iToF data processing circuit 45.

Next, at time t52, the switching control unit 407 switches the light emission setting to the dToF ranging. That is, the switching control unit 407 supplies the selection control signal for selecting the dToF ranging to the selector 403, the pixel modulation unit timing adjustment unit 404, and the TDC timing adjustment unit 405. Therefore, from time t52 to time t54, the selector 403 selects and outputs the reference pulse from the dToF reference pulse generation unit 402 as the light emission pulse, and the pixel modulation unit timing adjustment unit 404 and the pixel modulation unit 63 are set to the standby state. The iToF data processing circuit 45 executes predetermined data processing on the basis of the pixel signal supplied from each iToF pixel 141, and outputs a result of calculating the distance to the object as the ranging data.

Furthermore, from time t53 to time t54, the light emission timing adjustment unit 406 outputs the light emission pulse supplied from the selector 403 to the LD 12. The TDC 83 generates a count value from when the irradiation light is emitted to when this is received by the dToF pixel region 81 on the basis of the light emission pulse supplied from the TDC timing adjustment unit 405, and supplies the same to the dToF data processing circuit 47.

Next, at time t54, the switching control unit 407 switches the light emission setting to the iToF ranging. That is, the switching control unit 407 supplies the selection control signal for selecting the iToF ranging to the selector 403, the pixel modulation unit timing adjustment unit 404, and the TDC timing adjustment unit 405. Therefore, from time t54 to time t56, the selector 403 selects and outputs the reference pulse from the iToF reference pulse generation unit 401 as the light emission pulse, and the TDC timing adjustment unit 405 and the TDC 83 are set to the standby state. The dToF data processing circuit 47 generates a histogram on the basis of the count value supplied from each dToF pixel 201 in the dToF pixel region 81, calculates the distance to the object on the basis of the count value of the peak of the histogram, and outputs a result as the ranging data.

Furthermore, from time t55 to time t56, the light emission timing adjustment unit 406 outputs the light emission pulse for the iToF ranging supplied from the selector 403 to the LD 12. The pixel modulation unit 63 performs the exposure on the basis of the light emission pulse supplied from the pixel modulation unit timing adjustment unit 404, and supplies the pixel signal corresponding to the amount of received light to the iToF data processing circuit 45.

Next, at time t56, the switching control unit 407 switches the light emission setting to the dToF ranging. That is, the switching control unit 407 supplies the selection control signal for selecting the dToF ranging to the selector 403, the pixel modulation unit timing adjustment unit 404, and the TDC timing adjustment unit 405. Therefore, from time t56 to time t58, the selector 403 selects and outputs the reference pulse from the dToF reference pulse generation unit 402 as the light emission pulse, and the pixel modulation unit timing adjustment unit 404 and the pixel modulation unit 63 are set to the standby state. The iToF data processing circuit 45 executes predetermined data processing on the basis of the pixel signal supplied from each iToF pixel 141, and outputs a result of calculating the distance to the object as the ranging data.

Furthermore, from time t57 to time t58, the light emission timing adjustment unit 406 outputs the light emission pulse for the dToF ranging supplied from the selector 403 to the LD 12. The TDC 83 generates a count value from when the irradiation light is emitted to when this is received by the dToF pixel region 81 on the basis of the light emission pulse supplied from the TDC timing adjustment unit 405, and supplies the same to the dToF data processing circuit 47.

Next, at time t58, the switching control unit 407 switches the light emission setting to the iToF ranging. That is, the switching control unit 407 supplies the selection control signal for selecting the iToF ranging to the selector 403, the pixel modulation unit timing adjustment unit 404, and the TDC timing adjustment unit 405. Therefore, from time t58 to time t60, the selector 403 selects and outputs the reference pulse from the iToF reference pulse generation unit 401 as the light emission pulse, and the TDC timing adjustment unit 405 and the TDC 83 are set to the standby state. The dToF data processing circuit 47 generates a histogram on the basis of the count value supplied from each dToF pixel 201 in the dToF pixel region 81, calculates the distance to the object on the basis of the count value of the peak of the histogram, and outputs a result as the ranging data.

Furthermore, from time t59 to time t60, the light emission timing adjustment unit 406 outputs the light emission pulse for the iToF ranging supplied from the selector 403 to the LD 12. The pixel modulation unit 63 performs the exposure on the basis of the light emission pulse supplied from the pixel modulation unit timing adjustment unit 404, and supplies the pixel signal corresponding to the amount of received light to the iToF data processing circuit 45.

The same applies to the operation after time t60.

By the above-described control, it is possible to perform the ranging by the iToF ranging and the dToF ranging in a time division manner for the same ranging range and output the ranging data. In the ranging sensor 11, one circuit that does not perform the operation of the iToF ranging or the dToF ranging is controlled to the standby state, so that it is possible to prevent occurrence of a useless operation and reduce power consumption.

### 13. Configuration Example of Electronic Device

The above-described ranging system 1 may be mounted on, for example, an electronic device such as a smartphone, a tablet terminal, a mobile phone, a personal computer, a game machine, a television receiver, a wearable terminal, a digital still camera, and a digital video camera.

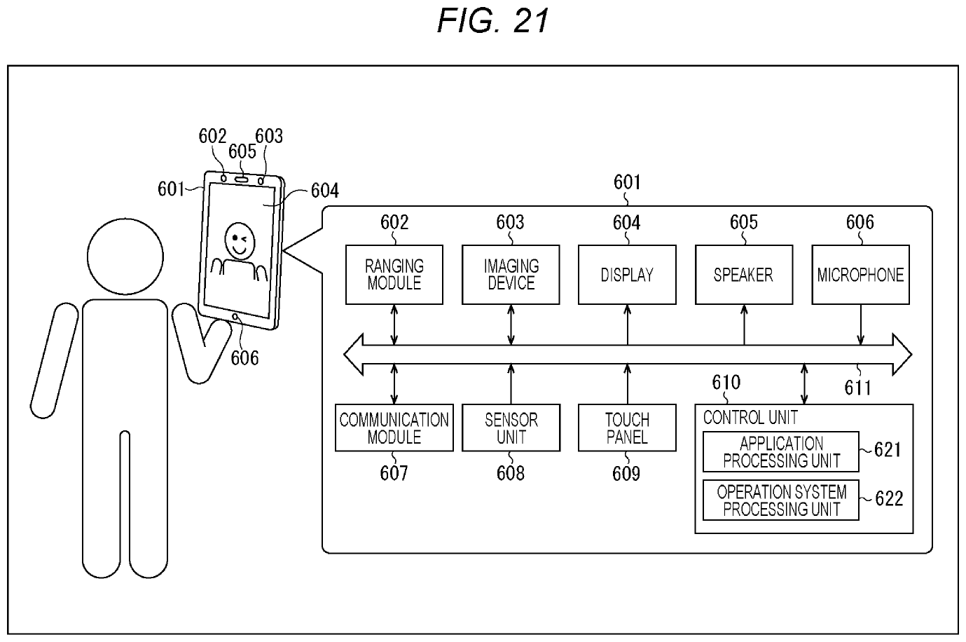

FIG. 21 is a block diagram depicting a configuration example of a smartphone in which the ranging system 1 described above is mounted as a ranging module.

As illustrated in FIG. 21, a smartphone 601 is formed by connecting a ranging module 602, an imaging device 603, a display 604, a speaker 605, a microphone 606, a communication module 607, a sensor unit 608, a touch panel 609, and a control unit 610 via a bus 611. Furthermore, the control unit 610 has functions as an application processing unit 621 and an operation system processing unit 622 by a CPU executing a program.

The ranging system 1 in FIG. 1 is applied to the ranging module 602. For example, the ranging module 602 is arranged on a front surface of the smartphone 601, and may perform ranging on a user of the smartphone 601 to output a depth value of a surface shape of the face, hand, finger and the like of the user as a ranging result.

The imaging device 603 is arranged on the front surface of the smartphone 601, and performs imaging of the user of the smartphone 601 as a subject to obtain an image in which the user is imaged. Note that, although not illustrated, the imaging device 603 may also be arranged on a rear surface of the smartphone 601.

The display 604 displays an operation screen for performing processing by the application processing unit 621 and the operation system processing unit 622, the image imaged by the imaging device 603 and the like. The speaker 605 and the microphone 606 output a voice of the other party and collect a voice of the user, for example, when talking on the smartphone 601.

The communication module 607 performs communication via a communication network. The sensor unit 608 senses speed, acceleration, proximity and the like, and the touch panel 609 obtains a touch operation by the user on an operation screen displayed on the display 604.

The application processing unit 621 performs processing for providing various services by the smartphone 601. For example, the application processing unit 621 may perform processing of creating a face by computer graphics virtually reproducing an expression of the user on the basis of the depth supplied from the ranging module 602 and displaying the same on the display 604. Furthermore, the application processing unit 621 may perform processing of creating three-dimensional shape data of an arbitrary solid object, for example, on the basis of the depth supplied from the ranging module 602.

The operation system processing unit 622 performs processing for implementing basic functions and operations of the smartphone 601. For example, the operation system processing unit 622 may perform processing of authenticating the face of the user and unlocking the smartphone 601 on the basis of the depth value supplied from the ranging module 602. Furthermore, on the basis of the depth value supplied from the ranging module 602, the operation system processing unit 622 may perform, for example, processing of recognizing a gesture of the user and processing of inputting various operations according to the gesture.

In the smartphone 601 configured as described above, by applying the above-described ranging system 1 as the ranging module, for example, the distance to a predetermined object as the subject may be measured and output as the ranging data.

### 14. Application Example to Mobile Body

The technology according to an embodiment of the present disclosure (present technology) is applicable to various products. For example, the technology according to the present disclosure may also be implemented as a device mounted on any type of mobile body such as an automobile, an electric automobile, a hybrid electric automobile, a motorcycle, a bicycle, a personal mobility, an airplane, a drone, a ship, and a robot, for example.

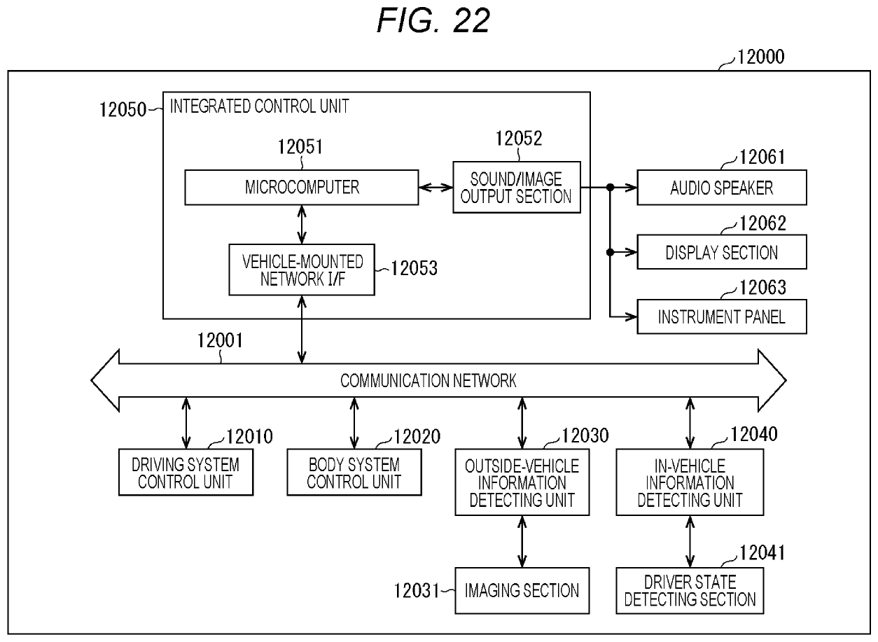

FIG. 22 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 22, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 may output a control command to the body system control unit 12020 on the basis of the information about the outside of the vehicle obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 22, an audio speaker 12061, a display section 12062, and an instrument panel 12063 are illustrated as the output device. The display section 12062 may, for example, include at least one of an on-board display and a head-up display.

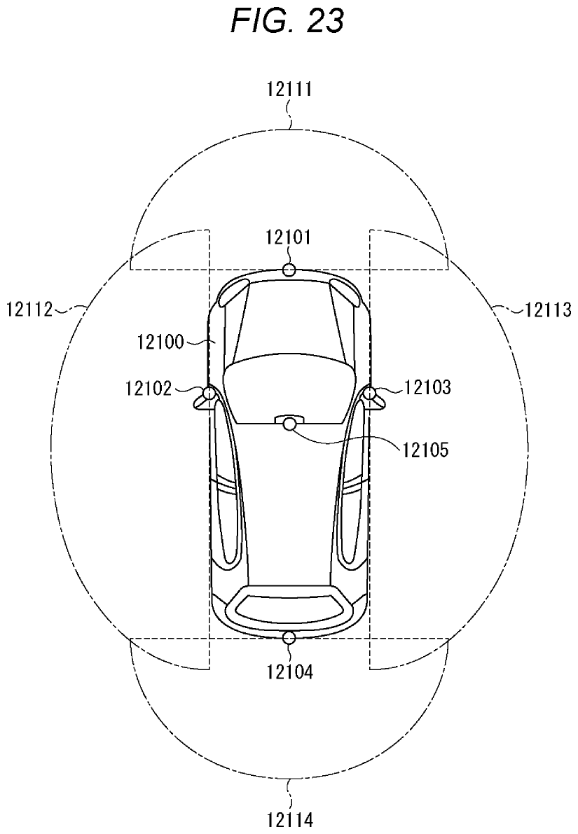

FIG. 23 is a diagram depicting an example of the installation position of the imaging section 12031.

In FIG. 23, the vehicle 12100 includes imaging sections 12101, 12102, 12103, 12104, and 12105 as the imaging section 12031.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The image of the front obtained by the imaging sections 12101 to 12105 are used mainly to detect a preceding vehicle, a pedestrian, an obstacle, a signal, a traffic sign, a lane, or the like.

Incidentally, FIG. 23 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to an embodiment of the present disclosure may be applied is described above. The technology according to an embodiment of the present disclosure may be applied to the imaging section 12031 out of the configurations described above. Specifically, the above-described ranging system 1 may be applied as the imaging section 12031. By applying the technology according to an embodiment of the present disclosure to the imaging section 12031, it is possible to obtain distance information by both dToF ranging and iToF ranging. Furthermore, it is possible to reduce driver fatigue and increase a degree of safety of the driver and the vehicle by using the obtained captured image and distance information.

The embodiments of the present technology are not limited to the above-described embodiments, and various modifications may be made without departing from the gist of the present technology.

As long as there is no inconsistency, each of a plurality of present technologies described in this specification may be independently implemented alone. It goes without saying that it is also possible to implement by combining any plurality of present technologies. For example, a part of or an entire present technology described in any embodiment may be implemented in combination with a part of or the entire present technology described in other embodiments. Furthermore, a part of or an entire any present technology described above may be implemented in combination with other technologies not described above.

Furthermore, for example, it is also possible to divide the configuration described as one device (or processing unit) into a plurality of devices (or processing units). Other way round, it is also possible to put the configurations described above as a plurality of devices (or processing units) together as one device (or processing unit). Furthermore, it goes without saying that it is possible to add a configuration other than the above-described one to the configuration of each device (or each processing unit). Moreover, it is also possible that a part of the configuration of a certain device (or processing unit) is included in the configuration of another device (or another processing unit) as long as a configuration and operation as an entire system are substantially the same.

Moreover, in this specification, the system is intended to mean assembly of a plurality of components (devices, modules (parts) and the like) and it does not matter whether or not all the components are in the same casing. Therefore, a plurality of devices accommodated in different casings and connected via a network and one device in which a plurality of modules is accommodated in one casing are the systems.

Note that, the effects described in this specification are illustrative only and are not limited; the effects other than those described in this specification may also be included.

Note that the present technology may also take the following configuration.

(1)

A ranging sensor including:
a light emission control circuit that generates a light emission pulse that controls a light emission timing of irradiation light;
a pixel modulation unit that performs charge distribution control in a pixel by a first ToF method; and
a TDC that generates a count value corresponding to a flight time of the irradiation light by a second ToF method, in which
the light emission control circuit is arranged adjacent to the pixel modulation unit and the TDC.

(2)

The ranging sensor according to (1) described above,
formed by stacking a first semiconductor substrate and a second semiconductor substrate, in which
the first semiconductor substrate includes a light receiving region that receives reflected light, which is the irradiation light reflected by an object, and
the second semiconductor substrate includes the light emission control circuit, the pixel modulation unit, and the TDC.

(3)

The ranging sensor according to (2) described above, in which
the first semiconductor substrate includes a first pixel region in which pixels that receive the reflected light by the first ToF method are arranged in a matrix, a second pixel region in which pixels that receive the reflected light by the second ToF method are arranged in a matrix, and a clearance region arranged between the first pixel region and the second pixel region.

(4)

The ranging sensor according to (2) or (3) described above, in which
the second semiconductor substrate further includes a power supply input unit that externally receives an input of power supply, and
the power supply input unit is arranged adjacent to the pixel modulation unit.

(5)

The ranging sensor according to (4) described above, in which
long sides of rectangular regions of the power supply input unit and the pixel modulation unit are arranged adjacent to each other.

(6)

The ranging sensor according to any one of (3) to (5) described above, in which
the TDC is arranged adjacent to an under-pixel circuit region including a pixel circuit corresponding to the second pixel region of the first semiconductor substrate.

(7)

The ranging sensor according to any one of (3) to (6) described above, in which
the second semiconductor substrate includes the TDC in a region corresponding to the clearance region of the first semiconductor substrate.

(8)

The ranging sensor according to any one of (3) to (7) described above, in which
the second semiconductor substrate further includes an ADC that AD-converts a pixel signal by the first ToF method in a region corresponding to the clearance region of the first semiconductor substrate.

(9)

The ranging sensor according to any one of (1) to (8) described above, in which
the light emission control circuit generates the light emission pulse by the first ToF method and the light emission pulse by the second ToF method in a time division manner.

(10)

The ranging sensor according to any one of (1) to (9) described above, in which
a circuit that generates the light emission pulse by the first ToF method and a circuit that generates the light emission pulse by the second ToF method are separately arranged as the light emission control circuit.

(11)

The ranging sensor according to any one of (1) to (10) described above,
formed by stacking a first semiconductor substrate, a second semiconductor substrate, and a third semiconductor substrate, in which
the first semiconductor substrate includes a light receiving region that receives reflected light, which is the irradiation light reflected by an object, and
the second semiconductor substrate includes the light emission control circuit, the pixel modulation unit, and the TDC.

(12)

The ranging sensor according to (11) described above, in which
the third semiconductor substrate includes a first data processing circuit that calculates ranging data by the first ToF method and a second data processing circuit that calculates ranging data by the second ToF method.

(13)

The ranging sensor according to (11) or (12) described above, in which
the second semiconductor substrate includes a pixel ADC region that performs pixel ADC in a region corresponding to a first pixel region of the first semiconductor substrate in which pixels that receive the reflected light are arranged in a matrix by the first ToF method.

(14)

The ranging sensor according to any one of (1) to (13) described above, in which
the first ToF method is an indirect ToF method, and
the second ToF method is a direct ToF method.

(15)

The ranging sensor according to any one of (1) to (14) described above, in which
the light emission control circuit includes:
a first pulse generation unit that generates a reference pulse by the first ToF method;
a second pulse generation unit that generates a reference pulse by the second ToF method; and
a selector that selects any one of the reference pulse of the first pulse generation unit or the reference pulse of the second pulse generation unit as the light emission pulse.

(16)

The ranging sensor according to (15), in which
the light emission control circuit further includes a switching control unit that controls any one of the pixel modulation unit or the TDC to a standby state.

(17)

The ranging sensor according to (15) or (16) described above, in which
the light emission control circuit includes:
a first adjustment unit that adjusts an output timing of the light emission pulse output to the pixel modulation unit;
a second adjustment unit that adjusts an output timing of the light emission pulse output to the TDC; and
a third adjustment unit that adjusts an output timing of the light emission pulse output to a light emission drive unit that drives a light emission unit that emits the irradiation light.

(18)

The ranging sensor according to (17) described above, in which
the first adjustment unit to the third adjustment unit are arranged on a subsequent stage of the selector.

(19)

A ranging system including:
a light emission unit that emits irradiation light; and
a ranging sensor that receives reflected light, which is the irradiation light reflected by an object, in which
the ranging sensor includes:
   a light emission control circuit that generates a light emission pulse that controls a light emission timing of the irradiation light;
   a pixel modulation unit that performs charge distribution control in a pixel by a first ToF method; and
   a TDC that generates a count value corresponding to a flight time of the irradiation light by a second ToF method, and
the light emission control circuit is arranged adjacent to the pixel modulation unit and the TDC.

(20)

An electronic device including:
a light emission unit that emits irradiation light; and
a ranging sensor that receives reflected light, which is the irradiation light reflected by an object, in which
the ranging sensor includes:
   a light emission control circuit that generates a light emission pulse that controls a light emission timing of the irradiation light;
   a pixel modulation unit that performs charge distribution control in a pixel by a first ToF method; and
   a TDC that generates a count value corresponding to a flight time of the irradiation light by a second ToF method, and
the light emission control circuit is arranged adjacent to the pixel modulation unit and the TDC.

### REFERENCE SIGNS LIST

1 Ranging system
10 Control device
11 Ranging sensor
12 LD
13 Light emission unit
43 Light emission control circuit
43a iToF light emission control circuit
43b dToF light emission control circuit
45 iToF data processing circuit
47 dToF data processing circuit
48 Output IF
61 iToF pixel region
62 iToF control circuit
63 Pixel modulation unit
64 ADC
81 dToF pixel region
82 dToF control circuit
83 TDC
101a First semiconductor substrate
101b Second semiconductor substrate
101c Third semiconductor substrate
111 iToF pixel region
112 SPAD pixel region
113 Clearance region
122 Under-pixel circuit region
123 Power supply input unit
141 iToF pixel
201 dToF pixel
221 Load element
222 SPAD
223 Inverter
401 iToF reference pulse generation unit
402 dToF reference pulse generation unit
403 Selector
404 Pixel modulation unit timing adjustment unit
405 TDC timing adjustment unit
406 Light emission timing adjustment unit
407 Switching control unit
601 Smartphone
602 Ranging module

1. A ranging sensor comprising:
a light emission control circuit that generates a light emission pulse that controls a light emission timing of irradiation light;
a pixel modulation unit that performs charge distribution control in a pixel by a first ToF method; and
a TDC that generates a count value corresponding to a flight time of the irradiation light by a second ToF method, wherein
the light emission control circuit is arranged adjacent to the pixel modulation unit and the TDC.

2. The ranging sensor according to claim 1,
formed by stacking a first semiconductor substrate and a second semiconductor substrate, wherein
the first semiconductor substrate includes a light receiving region that receives reflected light, which is the irradiation light reflected by an object, and
the second semiconductor substrate includes the light emission control circuit, the pixel modulation unit, and the TDC.

3. The ranging sensor according to claim 2, wherein
the first semiconductor substrate includes a first pixel region in which pixels that receive the reflected light by the first ToF method are arranged in a matrix, a second pixel region in which pixels that receive the reflected light by the second ToF method are arranged in a matrix, and a clearance region arranged between the first pixel region and the second pixel region.

4. The ranging sensor according to claim 2, wherein
the second semiconductor substrate further includes a power supply input unit that externally receives an input of power supply, and
the power supply input unit is arranged adjacent to the pixel modulation unit.

5. The ranging sensor according to claim 4, wherein
long sides of rectangular regions of the power supply input unit and the pixel modulation unit are arranged adjacent to each other.

6. The ranging sensor according to claim 3, wherein
the TDC is arranged adjacent to an under-pixel circuit region including a pixel circuit corresponding to the second pixel region of the first semiconductor substrate.

7. The ranging sensor according to claim 3, wherein
the second semiconductor substrate includes the TDC in a region corresponding to the clearance region of the first semiconductor substrate.

8. The ranging sensor according to claim 3, wherein
the second semiconductor substrate further includes an ADC that AD-converts a pixel signal by the first ToF method in a region corresponding to the clearance region of the first semiconductor substrate.

9. The ranging sensor according to claim 1, wherein
the light emission control circuit generates the light emission pulse by the first ToF method and the light emission pulse by the second ToF method in a time division manner.

10. The ranging sensor according to claim 1, wherein
a circuit that generates the light emission pulse by the first ToF method and a circuit that generates the light emission pulse by the second ToF method are separately arranged as the light emission control circuit.

11. The ranging sensor according to claim 1,
formed by stacking a first semiconductor substrate, a second semiconductor substrate, and a third semiconductor substrate, wherein
the first semiconductor substrate includes a light receiving region that receives reflected light, which is the irradiation light reflected by an object, and
the second semiconductor substrate includes the light emission control circuit, the pixel modulation unit, and the TDC.

12. The ranging sensor according to claim 11, wherein
the third semiconductor substrate includes a first data processing circuit that calculates ranging data by the first ToF method and a second data processing circuit that calculates ranging data by the second ToF method.

13. The ranging sensor according to claim 11, wherein
the second semiconductor substrate includes a pixel ADC region that performs pixel ADC in a region corresponding to a first pixel region of the first semiconductor substrate in which pixels that receive the reflected light are arranged in a matrix by the first ToF method.

14. The ranging sensor according to claim 1, wherein
the first ToF method is an indirect ToF method, and
the second ToF method is a direct ToF method.

15. The ranging sensor according to claim 1, wherein
the light emission control circuit includes:
a first pulse generation unit that generates a reference pulse by the first ToF method;
a second pulse generation unit that generates a reference pulse by the second ToF method; and
a selector that selects any one of the reference pulse of the first pulse generation unit or the reference pulse of the second pulse generation unit as the light emission pulse.

16. The ranging sensor according to claim 15, wherein
the light emission control circuit further includes a switching control unit that controls any one of the pixel modulation unit or the TDC to a standby state.

17. The ranging sensor according to claim 15, wherein
the light emission control circuit includes:
a first adjustment unit that adjusts an output timing of the light emission pulse output to the pixel modulation unit;
a second adjustment unit that adjusts an output timing of the light emission pulse output to the TDC; and
a third adjustment unit that adjusts an output timing of the light emission pulse output to a light emission drive unit that drives a light emission unit that emits the irradiation light.

18. The ranging sensor according to claim 17, wherein
the first adjustment unit to the third adjustment unit are arranged on a subsequent stage of the selector.

19. A ranging system comprising:
a light emission unit that emits irradiation light; and
a ranging sensor that receives reflected light, which is the irradiation light reflected by an object, wherein
the ranging sensor includes:
a light emission control circuit that generates a light emission pulse that controls a light emission timing of the irradiation light;
a pixel modulation unit that performs charge distribution control in a pixel by a first ToF method; and
a TDC that generates a count value corresponding to a flight time of the irradiation light by a second ToF method, and
the light emission control circuit is arranged adjacent to the pixel modulation unit and the TDC.

20. An electronic device comprising:
a light emission unit that emits irradiation light; and
a ranging sensor that receives reflected light, which is the irradiation light reflected by an object, wherein
the ranging sensor includes:
a light emission control circuit that generates a light emission pulse that controls a light emission timing of the irradiation light;
a pixel modulation unit that performs charge distribution control in a pixel by a first ToF method; and
a TDC that generates a count value corresponding to a flight time of the irradiation light by a second ToF method, and
the light emission control circuit is arranged adjacent to the pixel modulation unit and the TDC.
